(19) United States
(12) Patent Application Publication
(10) Pub. No.: US 2024/0029913 A1
(43) Pub. Date: Jan. 25, 2024

(54) SYSTEMS AND METHODS FOR DUALITY MODULATION SEPARATION OF CHARGED PARTICLE WAVE PACKETS

(71) Applicants: Stuart Mirell, Los Angeles, CA (US); Daniel Mirell, Irvine, CA (US)

(72) Inventors: Stuart Mirell, Los Angeles, CA (US); Daniel Mirell, Irvine, CA (US)

(21) Appl. No.: 18/130,416

(22) Filed: Apr. 3, 2023

Related U.S. Application Data
(60) Provisional application No. 63/326,694, filed on Apr. 1, 2022.

(51) Int. Cl. G21K 1/10; G01T 1/29; H01F 7/02; G21B 1/19

(52) U.S. Cl. CPC G21K 1/10; G01T 1/2985; H01F 7/0205; G21B 1/19

(57) ABSTRACT

There is disclosed a system for duality modulation separation of charged particle wave packets comprising a magnet cascade including a plurality of magnets arranged coaxially along a length of a beam path, a beam source coaxially aligned with the magnet cascade at an initial end of the beam path, the beam source providing a selected particle beam projected along the beam path; a particle deflection means located at a point along the beam path beyond the terminal end of a final magnet of the magnet cascade; wherein a selected particle emitted from the beam source travels along the beam path; wherein a significant characteristic fraction of a particle wave packet of the selected particle is an empty wave packet longitudinally separated from a particle-occupied wave packet along the beam path when the system is tuned with characteristic magnetic gradients and a characteristic particle beam velocity for the selected particle type.

### REFERENCES

The present application claims the benefit of and priority to a U.S. Provisional Patent Application Ser. No. 63/326,694, filed Apr. 1, 2022, which is hereby incorporated by reference in its entirety into the present application.

The present application makes reference to the following publications, each of which is incorporated herein by reference in its entirety into the present application:
[ref-1] S. G. Mirell, “Locally Real States of Photons and Particles,” Physical Review A, Vol. 65, 2002, Article ID: 032102/1-22 March (2002);
[ref-2] U.S. Patent Application Publication No. US 2019/0018175 A1, Jan. 17, 2019 by Stuart Gary Mirell and Daniel Joseph Mirell, “Polarization-based method and apparatus for generating duality modulated electromagnetic radiation”;
[ref-3] H. Batelaan, T. J. Gay, and J. J. Schwendiman, “Stern-Gerlach Effect for Electron Beams,” Physical Review Letters, Vol. 79, 4517 (1997);
[ref-4] D. Ehberger et al, “Highly coherent electron beam from a laser-triggered tungsten needle tip,” arXiv:1412.4584v1 [physics.optics] 15 Dec. 2014;
[ref-5] H. Schmidt-Bocking et al, “The Stern-Gerlach Experiment Revisited,” arXiv:1609.09311v1 [physics.hist-ph] 29 Sep 2016;
[ref-6] R. G. J. Fraser, Molecular Rays (Cambridge University Press, 1931), on “The Rabi Field” pp. 117-119;
[ref-7] S. E. Jones et al., “Neutron Emissions from Metal Deuterides,” in Tenth International Conference on Cold Fusion 2003 Cambridge, MA: LENR-CANR.org;
[ref-8] B. M. Steinetz et al., “Novel Nuclear Reactions Observed in Bremsstrahlung-Irradiated Deuterated Metals,” NASA/TP-20205001616 June 2020;
[ref-9] W. H. Breunlich et al., “Muon-catalyzed Fusion,” Annu. Rev. Nucl. Part. Sci. 1989.39:311-56;
[ref-10] J. T. Cremer et al., “Periodic magnetic field as a polarized and focusing thermal neutron spectrometer and monochromator,” Rev. Sci. Instrum. 81, 013902 (2010);
[ref-11] E. Segre, Nuclei and Particles (W. A. BENJAMIN, INC., New York, 1965) on Linear Accelerators, pp. 142-143; and
[ref-12] R. Engels et al., “Polarized Fusion,” ISSN 1063-7796, Physics of Particles and Nuclei, 2014, Vol. 45, No. 1, pp. 341-343, Pleiades Publishing, Ltd., 2014.

### BACKGROUND OF THE INVENTION

A basic underlying premise of the present invention is that the Probabilistic Interpretation of quantum mechanics (PI) is incomplete and a locally real representation of quantum mechanics (LR) provides a complete representation of quantum mechanics that yields new physical principles, as described in “Locally Real States of Photons and Particles,” which is incorporated herein by reference in its totality.¹ Based upon those principles, methods are deduced here for separating the wave packets of particles into duality modulated particle-occupied wave packets and empty wave packets that are similar to the occupied wave packets but lack the massive particle-like entity. 1 S. G. Mirell, “Locally Real States of Photons and Particles,” Physical Review A, Vol. 65, 2002, Article ID: 032102/1-22 March (2002).

In particular, these methods are related to the use of magnetic gradient fields to separate charged particle wave packets into discretely oriented, duality modulated occupied wave packets and totally depleted, objectively real empty wave packets, entities that do not even exist for PI. The invention teaches novel applications of these separated wave packets.

Quantum mechanically, both particles and photons are well-known to exhibit wave-like and particle-like properties. Novel polarization-based methods of duality modulation for extracting empty waves from photons and demonstrating the existence of those empty waves was described in U.S. Patent Publication No. US 2019/0018175 A1, which is incorporated herein in its totality by reference.² In that demonstration the inventors show that in the process of equilibrating a beam of ordinary photons and a beam of empty photon waves, the energy quanta of those ordinary photons are transferred onto the beam of empty wave packets. ² U.S. Patent Publication No. US 2019/0018175 A1, Jan. 17, 2019, by Stuart Gary Mirell and Daniel Joseph Mirell, “Polarization-based method and apparatus for generating duality modulated electromagnetic radiation.”

That demonstration for empty photon waves has profound implications for the utility of empty particle wave packets. For example, a beam of uncharged empty electron wave packets can readily penetrate deeply into a metal atomic lattice where the initially empty wave packets controllably deliver equilibrated free atomic conduction electrons into the lattice interior.

Similarly, the separated occupied wave packets also have significant utility. By subjecting an occupied particle wave packet to repeated empty wave separation processes, the wave packet itself can be reduced to a negligible value, leaving the occupied wave packet in a highly “enriched” duality modulation state. Interactions of such enriched wave packets with ordinary wave packets result in enhanced tunneling of the particle-like entity on the highly enriched wave packet onto the ordinary wave packet and into proximity with the particle-like entity residing on that ordinary wave packet.

In the present disclosure, the inventors describe novel methods of duality modulation for separating particle wave packets using particular magnetic field configurations. Despite the differences in the physical mechanisms used to extract empty waves from photons and from particles, the two processes are profoundly analogous with respect to their respective wave structures from the perspective of LR. [ref-1] LR is a particular locally real representation of quantum mechanics that is consistent with the underlying mathematical quantum mechanical formalism but is distinct from the widely accepted Probabilistic Interpretation PI of that formalism.

With regard to objectively real representations of photons and particles in LR, both are shown to be described by an orientation factor that augments the wave function of the standard quantum mechanical formalism. In both cases, the orientation factor in the LR wave function specifies the orientation of a wave structure that is not defined in the standard quantum mechanical formalism. For photons, that structure consists of a uniform π/2 arc distribution of radially oriented, effectively planar, wave packet amplitudes in the plane transverse to the propagation axis. For spin ½ particles, the analogous structure is a uniform hemispherical 2π radial distribution of spinor amplitudes identified as a “spin structure”. A three-dimensional Gaussian coherence wave of these spin structures constitutes the particle wave packet. The objectively real orientations for these structures are defined by the transverse arc bisector θₐ for a photon wave packet, and, in spherical coordinates, by the spin structure pole angles θₚ,φₚ for a particle wave packet, respectively the polar and azimuthal angles relative to the +z axis.

Significantly, the analogies for photons and particles extend to the projective condensations of their angularly distributed amplitudes when subjected respectively to an electromagnetic wave polarizer and to a high gradient magnetic field. The projections analogously occur along the respective symmetry axes of the polarizer and of the magnetic field.

Additionally, the strong LR analogs between photons and particles can be used to infer structural and dynamic properties of their respective waves. For example, a photon incident on a calcite crystal separates into an occupied wave and an empty wave. The trajectory that each follows within the crystal is independent of the presence or absence of a particle-like energy quantum on the wave. That presence or absence is determined by the transverse orientation of the incident wave. The empty wave of a photon is then recognized as having the properties of an electromagnetic wave fully consistent with Maxwell's equations but necessarily absent properties specifically relating to resident particle-like energy quanta.

Similarly, important physical properties of waves associated with particles can be deduced from an LR analysis in conjunction with the Stern-Gerlach experiment, SGE [ref-3]. A particle such as the unpaired 5s orbital electron of the Ag silver atom used in SGE is represented by a uniform coherence wave of spin structures [ref-1]. The 5s orbital wave on which the particle-like electron resides is suddenly subjected to a substantial continuously changing magnetic field upon entering and traversing the strong longitudinal gradient of the SGE magnet's exterior fringe field. As a consequence, the uniform 5s coherence wave of spin structures condenses to a progressively localized Dirac-delta Gaussian distribution of spin structures. Concurrently, the spinors of each of those spin structures projectively condense to a single spinor deterministically along whichever magnetic field + or −B axis intersects the hemispherical spin structure accompanied by a complementary single spinor that forms respectively on the opposing − or +B axis from the orthogonal projective condensation of each of those spin structures. The completion of those concurrent condensation processes resolves to a single “δ-form” spinor and a single, initially contiguous, complementary δ-form spinor that is anti-aligned relative to the other single δ-form spinor.

In that projective condensation process, the quantum force associated with the condensing spinors of the spin structure rotates the particle-like mass and its associated magnetic moment μ_{B} onto the spinor forming along the ±B axis that had intersected the spin structure resulting in that spinor being “occupied.” The complementary anti-aligned spinor is identified as an “empty” spinor. Relative to the initial uniform wave of spin structures on the 5s orbital, probability P is conserved in the condensation processes where, from the perspective of LR, probability is the integrated intensity of objectively real waves of the vacuum field.

From the perspective of PI, the occupied δ-form spinor aligned either along the +B or the −B axis corresponds respectively to a “directionally quantized” DQ electron state respectively either spin up or a spin down. Because of the negative value of μ_{B} relative to electron spin, the μ_{B} residing on the occupied δ-form spinor is anti-aligned to the respective +B or −B axis. The objective of SGE is to physically distinguish the Ag atoms with those two discrete μ_{B} orientations by using a very strong transverse magnetic gradient to differentially direct the associated occupied states onto deflectively separated trajectories as a demonstration of DQ. In contrast, a principal objective in the present disclosure is to analyze DQ from an LR perspective and to deduce novel methods to generate separated output beams of duality modulated highly enriched (occupied) wave packets and totally depleted (empty) wave packets from input beams of free particles.

Following the condensation processes in SGE, the initially contiguous occupied and the empty δ-form spinors begin to longitudinally separate because the longitudinal gradient exterior to the magnet accelerates only the occupied spinor and its coupled Ag atom. The sign of that acceleration is dependent upon the resultant orientation of the occupied spinor. During the transit through the longitudinal exterior gradient there is a continued rapid change magnetic field strength that maintains the condensed δ-form of those spinors.

As the occupied and empty longitudinally separated δ-form spinors enter the SGE magnet, the longitudinal gradient diminishes to a negligible level and is replaced by a strong transverse gradient. On the beam path within the magnet the occupied δ-form spinor on the Ag 5s orbital evolves back to a uniform coherence wave of spin structures along the 5s orbital. In that process the 5s electron on the Ag atom retains the B alignment that it had on the occupied δ-form spinor. That B-aligned 5s electron and its coupled Ag atom are slightly deflected from its initial beam path by the transverse gradient. Concurrently, the empty spinor evolves to a free, spatially extended Gaussian wave packet of spin structures and continues through the magnet un-deflected from its initial beam path.

As the 5s electron on a uniform coherence wave of spin structures coupled to the Ag atom, exits the transverse gradient field within the magnet and enters the longitudinal gradient field exterior to the distal side of the magnet, the uniform coherence wave on the 5s orbital is again similarly condensed to an occupied δ-form along the same ±B axis and a complementary anti-aligned empty δ-form spinor is again generated. The occupied δ-form is longitudinally accelerated as it continues through the longitudinal gradient exterior to the magnet.

Concurrently, the original, free empty spatially extended Gaussian wave packet of spin structures is similarly condensed to an anti-aligned δ-form spinor upon entering the region of a strong longitudinal gradient on the distal side of the magnet.

Beyond that region, where a strong exterior longitudinal gradient is no longer present, the three condensed δ-form waves return to their non-condensed spatially extended states. For the occupied δ-form, that involves an evolution back to a uniform coherence wave of spin structures on the 5s orbital. Because at this point the field gradient as well as the field magnitude B itself are negligible, the disruption of evolving spinors perturbs the prior electron's μ_{B} alignment along B to a random orientation on one of the constituent spinors of one of the spin structures on the 5s orbital.

Concurrently, the two empty spinors evolve to two free, spatially extended empty Gaussian wave packets of spin structures longitudinally separated from each other and from the electron Ag atom system from which they were derived. The empty wave packets have a very small but finite mass relative to that of the particle-like electron mass mₑ and are the particle analogs of “totally depleted” photon wave packets as described by the inventors in [ref-2]. The empty wave packet masses are each proportional to their respective probabilities (integrated wave intensities), P₁ and P₂.

The electron Ag atom system from which P₁ and P₂ are extracted is characterized by the loss of that probability from the initial probability Pₒ of the 5s uniform coherence wave of spin structures to a reduced P_{f}=Pₒ−(P₁+P₂). In that regard the final 5s electron wave is identified as the particle analog of an “enriched” photon wave packet. [ref-2].

### SUMMARY OF THE INVENTION

In this disclosure, the underlying LR directional quantization DQ process for SGE, which relates to electron spin states coupled to Ag atoms, is extended to free electrons and generalized to other charged “particles” such as atomic nuclei after adjusting for factors such as mass and magnetic moment. That underlying LR directional quantization process is then utilized to deduce methods to separately generate beams of duality modulated highly enriched (occupied) wave packets and beams of totally depleted (empty) wave packets from input beams of free particles such as atomic nuclei. Those methods for generating separate beams of duality modulated wave packets derived from particles are shown to be considerably less technically stringent than the demonstration of DQ for those particles.

Several years after SGE, Brillouin proposed experimental demonstration of free electron DQ using longitudinal magnetic gradients. See [ref-4]. Brillouin's proposal was largely dismissed at that time based upon presumptive theoretical impediments that were subsequently refuted. In recent years there has been renewed interest in Brillouin's proposal.

More recent investigations [ref-4] have analyzed the demonstration of DQ for free electrons. A longitudinal magnetic field is examined in such investigations to avoid adverse deflection by the Lorentz force which would otherwise obscure the demonstration of DQ, a problem that is not present in the original transverse magnet of SGE since the unpaired non-free 5s electron resides on a neutral atomic system.

By applying LR to longitudinal magnetic field and gradient configurations, the invention teaches methods for longitudinally separating wave packets of free electron particles into wave packets inclusive of that charged particle, i.e. an “occupied” wave packet, and a wave packet in which that particle is absent, i.e. an “empty” wave packet, and subsequently deflecting the occupied wave packets away from that longitudinal trajectory by an ancillary electric or magnetic field. For the invention, those deflections occur independent of the spin state of the occupied wave packets leaving only a beam of empty wave packets along the original longitudinal trajectory. In a preferred embodiment of the invention a highly coherent particle beam source is utilized such as that described by Ehberger for electrons [ref-5], in which case the resultant beam of empty wave packets is similarly coherent.

By the methods disclosed here the beams of empty wave packets must be clearly distinguished from the DQ methods for free electrons using longitudinal magnetic field and gradient configurations as proposed for example by Batelaan [ref-4]. For example, Batelaan's DQ methods necessitate that incident electrons be bunched into sufficiently short pulses. Moreover, for purposes of demonstrating DQ, those bunched electrons necessarily must be prepared with randomly oriented spins. As a fundamental principle, PI imposes ad hoc that the individual electrons within a bunch are then all in either of two discrete spin states relative to the magnetic field. The gradient action of the magnetic field must then longitudinally separate the electrons in a given pulse by either advancing or retarding them by state along the beam into two temporally experimentally resolvable pulses. The successful measurement of that resultant double pulse by an appropriate particle detector constitutes the DQ demonstration for free electrons.

It may be readily appreciated that achieving the requisite detectable macroscopic pulse separation of the two spin state pulses for a successful SGE demonstration is technically a more challenging task than that of merely microscopically longitudinally separating occupied and empty wave packets in the present invention where a subsequent electric or magnetic ancillary field readily deflects the duality enriched occupied wave packets out of the beam leaving only empty wave packets on that beam. Concurrently, the deflected enriched occupied wave packets constitute a separate beam.

In a preferred embodiment using a coherent particle beam source, that empty wave beam is itself coherent in direct analogy to the empty wave photon beam disclosed by the inventors in [ref-2].

Additionally, with the use of a multiplicity of longitudinal magnetic field stages, the invention then provides, for each input particle wave packet, twice that multiplicity of output empty waves and efficiently extracts in totality a large proportion of the initial wave intensity of each incident particle wave packet.

As with the photon empty wave beams disclosed in [ref-2], the present particle empty wave beam also provides for several diverse applications that in part substantially overlap with those of [ref 2], e.g. stealthy communications and radar as well as imaging, but employing a physically distinctly different empty wave radiation. Additionally, empty electron wave packets uniquely provide means for inducing charge screening in metal lattices loaded with fusible nuclei and for providing an inertial force beam.

The disclosed methods are applied to wave packets of free electrons and to wave packets of other free charged particles such as atomic nuclei including for example protons, deuterons, and tritons. In those applications to nuclei the requisite magnetic field parameters are scaled to accommodate the respective particle properties and their velocities. Novel applications are disclosed for the resultant empty wave packets as well as for the enriched occupied wave packets. For example, the empty wave packets of nuclei directed at target nuclei provides for enhanced mutual tunneling of neighboring target nuclei. Alternatively, highly enriched occupied wave packets of nuclei directed at stationary target nuclei provide for enhanced mutual tunneling of directed and target nuclei.

FIG. 1A is a diagrammatic one-dimensional representation of a particle wave function for a wave packet consistent with the standard quantum mechanical formalism. The wave packet intensity of that amplitude is a Gaussian probability envelope and the oscillatory amplitude curve denotes the phase aspect of that amplitude.

FIG. 1B shows, from the perspective of local realism LR, the objectively real structure shown in FIG. 1A representation consists of a coherent continuum of spin structures. For a spin ½ particle, a sampling of the hemispherical spin structures at points along the wave packet is depicted in a one-dimensional representation of that wave packet. The relative sizes of the spin structures are used to represent the corresponding wave intensities at the respective points along the probability envelope. The spin structures of a given wave packet have a common orientation and the phase aspect along the wave packet is embodied in the spin structures.

FIG. 1C is a detailed selected cross-sectional example of one of the FIG. 1B spin structures. A set of spinors emanate from a point on the z-axis and collectively define a hemispherical surface. The common orientation of the spin structures in spherical coordinates is given by the polar angle θₚ relative to the z axis of the hemispherical pole and the azimuthal angle φₚ of that pole about that axis. The particular depicted FIG. 1C cross sectional example transects the spin structure through the plane that includes the orientation-defining pole at θₚ,φₚ.

The particle-like entity with its magnetic moment μ, represented by a solid dot, instantaneously resides on one of the spinors of a wave packet spin structure. For instructional purposes that particle-like entity is shown on the particular spin structure cross section depicted in FIG. 1C. The orientation of that particle-like mass entity is identified as θ_{M},φ_{M}. That selected cross section then uncommonly facilitates the simultaneous planar depiction of the spin structure pole orientation and the magnetic moment “occupied” spinor orientation.

FIG. 2A is a plane side cross section of a short tubular permanent magnet suitable for splitting (charged) particle wave packets with a longitudinal magnetic field gradient. The particle beam path is collinear is to the symmetry axis of the magnet and its magnetic field.

FIG. 2B depicts a plane side cross section of a solenoid electromagnet that is, relative to the FIG. 2A magnet, similarly suitable for splitting (charged) particle wave packets with a longitudinal magnetic field gradient and similarly provides a particle beam path collinear to the symmetry axis of the magnet and its magnetic field.

FIG. 2C depicts an approximate relative longitudinal magnetic field strength along the symmetry axis of the FIGS. 2A and 2B magnets. The similar geometry of those magnets results in a characteristic axial field: a negligible distal field, followed by an inflection at a one radius distance from the magnet to a high gradient field, converging at a second inflection at a short distance within the magnet bore to a relatively uniform field.

FIG. 3A depicts the configuration of components for separating particle wave packets into duality modulated occupied wave packets and empty wave packets showing the particle beam source, a sequence of magnets such the depicted FIG. 2A (permanent magnet), the first of which is illustrated in cross section, and a charged plate deflection means for extracting the duality modulated occupied wave packets from the principal longitudinal beam trajectory.

Unless otherwise specified to the contrary, magnets depicted in this and subsequent figures may be either of the solenoid electromagnet type or the permanent magnet type. In general, in any particular application one type is preferred for practical matters such as attainable magnetic fields, power consumption, cost and field adjustability.

FIG. 3B depicts a variant of the FIG. 3A configuration that further includes a magnet, shown in cross section, with a divergent bore as the final magnet in the sequence of magnets, and, viewed on edge, a two-stage charged plate deflection means for extracting the duality modulated occupied wave packets onto a parallel-displaced trajectory relative to that of the principal longitudinal beam trajectory.

FIG. 3C shows a projective view of an electromagnet solenoid coil that encircles axially-located stationary target particles and an incident beam along which particle wave packets are directed. An impulse current to the coil provides for a temporally imposed axial magnetic gradient on the stationary target particles.

FIG. 4 shows a temporal sequence of particle wave packet probability envelopes that depicts the rapid wave packet condensation process that occurs as a result of a sudden encounter with a substantial gradient magnetic field.

FIG. 5 is a representation showing the initial wave packet spin structures progressively reducing to a single remaining spin structure as the wave packet first enters a strong magnetic gradient.

FIG. 6 depicts the concurrent projective condensation of constituent spinors associated with the individual spin structures, shown at an intermediate stage of projective condensation and at the final projective condensation resolution of all of the spinors on the multiple spin structures to two initially contiguous, orthogonal “δ-form” spinors.

FIG. 7 shows the two orthogonal, final resolution δ-form spinors in the process of progressive longitudinal separation from each other as the two transit the high gradient region of the beam path.

FIG. 8. In the transitional region of the gradient after the longitudinally separated empty δ-form spinor and the occupied δ-form spinor leave the high gradient region and briefly traverse a lower gradient region, the δ-form spinors promptly begin to evolve back respectively to an empty spin structure and an occupied spin structure while concurrently those two spin structures both evolve back toward spatially extended coherence wave packets of spin structures. In this process, for the occupied wave packet, the particle-like entity with its magnetic moment μ remains on a spinor along the z axis because of the continued presence of a strong magnetic field along that z axis.

FIG. 9. As the two wave packets enter a region of a substantially constant field within the magnet bore, the evolution to respective spatially extended coherence wave packets of spin structures is complete and the two wave packets transit that substantially constant field region in that form. During this transit the particle-like entity with its magnetic moment μ remains on a spinor along the z axis on the occupied wave packet.

FIG. 10. depicts the emergent wave packets for a magnet with a strong proximal and distal gradient, an empty wave packet followed by an occupied wave packet followed by an empty wave packet.

FIG. 11 shows a communications system utilizing empty electron wave packets that incorporates a temporally modulated FIG. 3A configuration which encodes that modulation onto an empty wave packet beam distally received by a detector that is internally sensitive to variations of electron tunneling.

FIG. 12 depicts an imaging system utilizing empty electron wave packets that incorporates the FIG. 3A configuration that directs an empty wave packet beam on a defined trajectory through an object to be imaged. A detector that is internally sensitive to variations of electron tunneling receives the transmitted beam thereby providing for a measurement of empty wave packet attenuation along that defined trajectory.

FIG. 13 shows a multiplicity of FIG. 3A assemblies focally and synchronously directing empty electron wave packets at a centrally located metal lattice target loaded with fusible nuclei. FIG. 13 is also applicable to empty wave packets of fusible nuclei similarly directed.

FIG. 14 depicts a configuration of a FIG. 3A assembly for directing a beam of highly enriched wave packets of fusible nuclei into a gas containment vessel of fusible nuclei molecules and, in an alternate embodiment, a plasma containment vessel of fusible nuclei.

FIG. 15 depicts a modified FIG. 3B assembly in which a divergent bore final magnet, shown in cross section, provides occupied wave packets of fusible nuclei that have axial spin alignment as well as high enrichment. Those occupied wave packets, accelerated to a high energy by longitudinal accelerator means, are incident on a solid target of fusible nuclei. The target is located within a high-impulse field electromagnet solenoid loop.

FIG. 16 illustrates a method for enhancing fusion by enriching wave packets of nuclei such as tritons and directing them to a metal lattice loaded with fusible nuclei such as deuterons.

In some implementations, the system for duality modulation separation of charged particle wave packets comprises a magnet cascade including a plurality of magnets arranged coaxially along a length of a beam path, wherein the each of the plurality of magnets comprises a magnetic field axially symmetric relative to the beam path, the plurality of magnets creating magnetic gradient regions proximate to an initial end and a terminal end of each of the plurality of magnets along the beam path, a beam source coaxially aligned with the magnet cascade at an initial end of the beam path, the beam source providing a selected particle beam projected along the beam path, a particle deflection means located at a point along the beam path beyond the terminal end of a final magnet of the magnet cascade, wherein a selected particle emitted from the beam source travels along the beam path and encounters a first initial magnetic gradient region as it approaches the initial end of a first magnet, encounters a first terminal magnetic gradient region as it passes the terminal end of the first magnet, encounters a final initial magnetic gradient region as it approaches the initial end of a last magnet, and encounters a final terminal magnetic gradient region as it passes the terminal end of the last magnet, wherein a significant characteristic fraction of a particle wave packet of the selected particle is an empty wave packet longitudinally separated from a particle-occupied wave packet along the beam path when the system is tuned with characteristic magnetic gradients and a characteristic particle beam velocity for the selected particle type, wherein the selected particle emerging from the terminal end of the last magnet comprises a highly enriched occupied wave packet and a plurality of empty wave packets, wherein a number of the plurality of empty wave packets is twice the number of magnets in the magnet cascade, and wherein the highly enriched occupied wave packet is enriched by the separation of the plurality of empty wave packets as the selected particle traverses the magnetic gradient regions along the beam path, and wherein the highly enriched wave packet is deflected by the particle deflection means along a deflected beam path and wherein the plurality of empty wave packets continue on the beam path forming an empty wave packet beam.

In some implementations, the system the last magnet of the magnet cascade comprises a terminal magnetic gradient that is below a threshold for inducing duality modulation of the charged particle wave packets, and wherein a magnetic moment of the highly enriched occupied wave packet remains axially aligned.

In some implementations, a secondary deflection means for deflecting the highly enriched occupied wave packets deflected from the selected particle beam creating a secondary beam consisting of highly enriched occupied wave packets, and wherein only empty wave packets continue along the beam path.

In some implementations, the plurality of magnets of the magnet cascade are each hollow cylindrical magnets having an outer radius and comprising a central a bore having an inner radius, wherein the particle beam is substantially centered through the coaxially aligned bores of the plurality of magnets.

In some implementations, the system for producing transient alignment of magnetic moments of stationary target nuclei wave packets comprises a solenoidal coil magnet encircling the stationary atoms of nuclei, and a pulsed electrical power supplied to the coil that generates a concurrent transient temporal axial magnetic gradient, wherein the magnitude of the transient temporal axial magnetic gradient is sufficient to induce a concurrent transient duality modulation alignment of nuclear magnetic moments, and wherein the magnetic moments of the stationary target nuclei are transiently axially aligned relative to the transient axial gradient of the magnet.

In some implementations, the beam source is an electron beam source, wherein the selected particle is an electron, the system further comprises an energy recovery device, and wherein a beam of enriched electron wave packets travelling along the beam path is directed to the energy recovery device, and wherein a projection of a beam of empty electron wave packets along the beam path, results in a net reaction force in a direction opposite to a direction of travel of the electron.

In some implementations, the beam source is an electron beam source, wherein the selected particle beam is an electron beam, wherein the system is used for communications, the system further comprises a modulation means for encoding a signal into electron wave packets of the electron beam, wherein the transmitted beam of empty wave packets includes the modulated signal, and a receiver including detector means sensitive to incident empty electron wave packets, wherein the receiver includes a demodulator to decode the signal encoded in the empty electron wave packet, and wherein an encoded signal is transmitted to the receiver on an empty electron wave packet beam that is not detectable by conventional means.

In some implementations, the beam source is an electron beam source, wherein the selected particle beam is an electron beam, wherein the system is configured for imaging objects with a beam of empty electron wave packets, the system further comprises a receiver including a detector means sensitive to incident empty electron wave packets, the receiver configured to conventionally compile and process detector output signals, wherein an object interposed between the beam source and the receiver is intersected by the electron beam, and wherein a relative object attenuation of the electron beam in the object for that particular linear path measured by the detector, and wherein, based on a plurality of attenuation measurements are taken for a plurality of sampling paths through the object at a corresponding plurality of orientations, the system generates a tomographic image of the object without consequential energy deposition in the object from the beam of empty electron wave packets.

In some implementations, the beam source is an electron beam source, wherein the selected particle beam is an electron beam comprising an empty wave packet beam including empty electron wave packets, wherein the system is configured to induce fusion by charge screening, the system comprises a metal lattice loaded with fusible nuclei, wherein the empty wave packet beam is directed at the lattice and wherein metal lattice conduction electrons proximate to the empty wave packet beam equilibrate onto empty electron wave packets of the empty wave packet beam increasing a charge screening of fusible nuclei proximate to the empty wave packet beam path.

In some implementations, the system further comprising a plurality of electron beam sources and a corresponding plurality of magnet cascades generating a plurality of empty wave packet beams, wherein the plurality of empty wave packet beams are focused at a metal lattice loaded with fusible nuclei, and wherein equilibrated metal lattice conduction electrons on the plurality of empty wave packet beams enhance a charge screening at the focal region of the empty wave packet beams within the lattice.

In some implementations, the beam source is a fusible particle beam source, wherein the selected particle beam is a fusible particle beam, wherein the system is configured for inducing fusion by enhanced tunneling of fusible particles utilizing fusible-particle empty wave packets comprises a metal lattice loaded with fusible particles, wherein the fusible-particle empty wave packet beam is directed at the metal lattice, and wherein the empty wave packets of the fusible-particle empty wave packet beam increase the wave intensity between neighboring wave packets of fusible particles within the lattice encouraging fusion of neighboring fusible particles based on a mutual tunneling to fusion of those neighboring fusible particles.

In some implementations, the system further comprises a plurality of fusible particle beam sources and a corresponding plurality of magnet cascades generating a plurality of empty fusible particle wave packet beams, wherein the plurality of empty fusible particle wave packet beams are focally directed at a metal lattice loaded with fusible particles, wherein the empty fusible particle wave packets on the focally directed fusible particle beams further increase a wave intensity between neighboring wave packets of fusible nuclei within the lattice enhancing a mutual tunneling to fusion of neighboring fusible particles.

In some implementations, the beam source is a fusible particle beam source, wherein the selected particle beam comprises a highly enriched fusible particle beam, wherein the system is configured for inducing fusion by enhanced tunneling of fusible particles utilizing fusible-particle empty wave packets comprises a target of gaseous molecules with atomic nuclei consisting of ordinary wave packets of fusible particles, wherein the fusible particle beam is directed into the target of gaseous molecules, wherein the highly enriched wave packets of fusible particles displace ordinary wave packets of fusible particles in the gaseous molecules, and wherein the highly enriched wave packets of fusible particles exhibit enhanced fusion by tunneling onto ordinary wave packets of fusible particles that remain in target molecules.

In some implementations, the system for inducing fusion by enhanced tunneling of enriched wave packets of fusible particles onto ordinary wave packets of fusible particles in a plasma state further comprises a source beam of fusible particles for the generator, and a linear accelerator for substantially increasing the kinetic energy of charged particle wave packets, and a plasma target of ordinary wave packets of fusible particles and electrons in ionic form, and wherein, the generator output beam of enriched particle wave packets is directed at a linear accelerator for substantially increasing the kinetic energy of the enriched fusible particles, and wherein the resultant beam of high energy, enriched fusible particles is directed into the plasma target, and whereby the high energy, highly enriched wave packets of fusible particles exhibit enhanced fusion by tunneling onto the ordinary wave packets of fusible particles.

In some implementations, the beam source produces a pulsed beam of fusible particles for inducing fusion by enhanced tunneling of enriched fusible aligned wave packets onto ordinary wave packets of fusible aligned particles, the system further comprises a divergent geometry of a terminal output bore of the last magnet resulting in a substantially reduced terminal magnetic gradient, wherein the fusible particles of the enriched particle wave packets are axially aligned, a linear accelerator into which the pulsed beam of fusible particles is directed, substantially increasing the kinetic energy of the fusible particles, a solenoidal coil magnet with a pulsed electrical power supplied to the coil that generates a concurrent transient temporal axial magnetic gradient, stationary target atoms with fusible-particle nuclei encircled by the solenoidal coil magnet where those nuclei are transiently driven into axial alignment by the coil magnet gradient, wherein the beam pulses are synchronously incident on the stationary target atoms during the pulsed imposition of transient temporal axial magnetic gradient, and wherein mutual axial alignment, high collision energy, and enrichment asymmetry all concurrently contribute to inducing mutual fusion of the beam particles and the target particles.

In some implementations, the system is configured to induce fusion of highly enriched fusible particles wave packets and matrix loaded ordinary fusible particles wave packets, wherein the beam source is a fusible particle beam source, and the system further comprises ordinary wave packets of fusible target particles densely loaded into a thin metal matrix, a gas containment vessel in which the metal matrix is located, the gas containment vessel pressurized with molecules having the target particles as nuclei thereby maintaining the densely loaded condition of the matrix, wherein the beam of highly enriched fusible particles is directed onto the densely loaded metal matrix, and the highly enriched wave packets of fusible particles enter the densely loaded metal matrix, and wherein the proximity of the highly enriched fusible particle wave packets to the wave packets of fusible target particles in the densely loaded metal matrix results in mutual fusion by enrichment asymmetry.

### BRIEF DESCRIPTION OF THE DRAWINGS

FIG. 1A shows a diagram of a particle wave function for a wave packet consistent with the standard quantum mechanical formalism, according to one implementation of the present disclosure;

FIG. 1B shows a diagram of a particle wave function for a wave packet consistent with local realism LR, according to one implementation of the present disclosure;

FIG. 1C shows a diagram of a cross-sectional example of one of the spin structures shown in FIG. 1B, according to one implementation of the present disclosure;

FIG. 2A depicts a cross-section of a short tubular permanent magnet suitable for duality modulation separation of charged particle wave packets, according to one implementation of the present disclosure;

FIG. 2B depicts a cross-section of a solenoid electromagnet suitable for duality modulation separation of charged particle wave packets, according to one implementation of the present disclosure;

FIG. 2C shows a diagram of an approximate relative longitudinal magnetic field strength along the symmetry axis of the magnets depicted in FIGS. 2A and 2B, according to one implementation of the present disclosure;

FIG. 3A shows a schematic of a system suitable for duality modulation separation of charged particle wave packets, according to one implementation of the present disclosure;

FIG. 3B shows a schematic of a variant of the system of FIG. 3A suitable for duality modulation separation of charged particle wave packets;

FIG. 3C shows a schematic of an electromagnet solenoid coil that encircles axially-located stationary target particles and an incident beam along which particle wave packets are directed, according to one implementation of the present disclosure;

FIG. 4 is a diagram showing a temporal sequence of particle wave packet probability envelopes that depicts the rapid wave packet condensation process that occurs as a result of a sudden encounter with a substantial gradient magnetic field, according to one implementation of the present disclosure;

FIG. 5 is a diagram showing the initial wave packet spin structures progressively reducing to a single remaining spin structure as the wave packet first enters a strong magnetic gradient, according to one implementation of the present disclosure;

FIG. 6 is a diagram showing the concurrent projective condensation of constituent spinors associated with the individual spin structures of charged particle wave packets, according to one implementation of the present disclosure;

FIG. 7 is a diagram showing the two orthogonal, final resolution δ-form spinors in the process of progressive longitudinal separation from each other as the two transit the high gradient region of the beam path, according to one implementation of the present disclosure;

FIG. 8 shows diagrams depicting devolution of spin structures as charged particle wave packets leave the high gradient region and briefly traverse a lower gradient region, according to one implementation of the present disclosure;

FIG. 9 shows a diagram depicting two wave packets entering a region of a substantially constant field within the magnet bore of the system of FIG. 2A, according to one implementation of the present disclosure;

FIG. 10. shows a diagram depicting the emergent wave packets for a magnet with a strong proximal and distal gradient, an empty wave packet followed by an occupied wave packet followed by an empty wave packet, according to one implementation of the present disclosure;

FIG. 11 shows a schematic of a communications system utilizing empty electron wave packets, according to one implementation of the present disclosure;

FIG. 12 shows a schematic of an imaging system utilizing empty electron wave packets, according to one implementation of the present disclosure;

FIG. 13 shows a schematic of a fusion-encouraging system utilizing empty electron wave packets, according to one implementation of the present disclosure;

FIG. 14 shows a schematic of an assembly for directing a beam of highly enriched wave packets of fusible nuclei into a gas containment vessel of fusible nuclei molecules according to one implementation of the present disclosure;

FIG. 15 shows a schematic of an assembly in which a divergent bore final magnet, shown in cross section, provides occupied wave packets of fusible nuclei that have axial spin alignment as well as high enrichment, according to one implementation of the present disclosure;

FIG. 16 shows a schematic of an assembly for enhancing fusion, according to one implementation of the present disclosure.

### DETAILED DESCRIPTION OF THE INVENTION

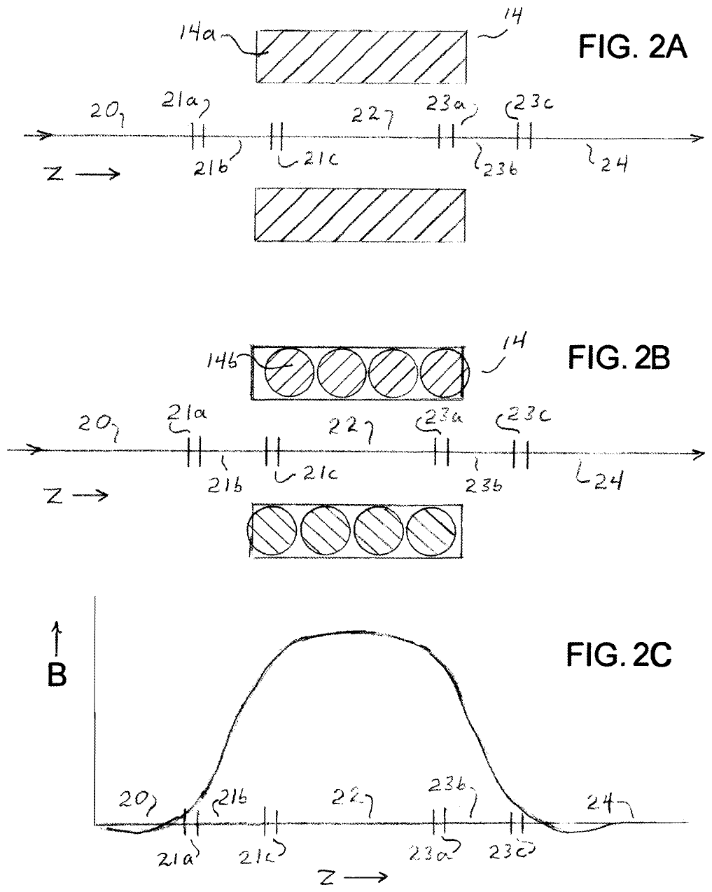

(1.) Reference [ref-1] demonstrates the strong analogies between photon and particle waves.
(2.) These analogies extend to wave structure condensation of photons traversing polarizers [ref-2] and unpaired atomic electrons traversing high magnetic field gradients that include the empty waves produced in those two condensation processes.
(3.) The LR analysis of the Stern-Gerlach Experiment SGE [ref-3] presented here provides novel insights into the underlying mechanism of the observed “directional quantization” DQ, insights not accessible when applying the widely accepted Probabilistic Interpretation PI of quantum mechanics. That LR analysis applied to SGE shows that DQ occurs as a non-adiabatic process in which an unpaired orbital atomic electron particle wave suddenly enters a high longitudinal magnetic gradient exterior to SGE magnets. The initiation of the DQ process in SGE can be deduced from LR to be a threshold value that is the product of the gradient magnitude and beam velocity. That threshold can be approximated from SGE.
(4.) Investigated methods for extending DQ to beams of free electrons have included solenoidal magnets that avoid detrimental Lorentz force by directing beams along the magnet's axial longitudinal field. [ref-3] From LR, it can be deduced that solenoid electromagnets magnets and tubular permanent magnets with longitudinal gradients can be modified for objectives of the invention as the principal duality modulation component in generating the duality modulation separation of a charged particle wave packet into an enriched wave packet and a totally depleted (empty) wave packet. Those objectives are shown to be distinct from the demonstration of DQ in SGE and Batelaan [ref-3]. LR analysis of the wave packet is applied to each beam segment for single magnets of the types depicted in FIGS. 2A and 2B.
(5.) The requisite modifications to extend those magnets in conjunction with various input charged particle beams to the objectives of the invention are approximated by SGE parameters. The resultant modifications are further refined empirically by the novel utilization of beam polarimetry measurements that are deduced to provide assessment of duality modulation separation.
(6.) It is further be deduced that for the objectives of the invention the output of a single such magnet can be greatly enhanced by configuring a sequential cascade of such magnets as individual “stage” components to separate a charged particle wave packet into a highly enriched particle wave packet and twice that multiplicity of totally depleted (empty) wave packets from the final output of that sequential cascade. Statistical averages are calculated for outputs of FIGS. 2C and 2C-a cascades.

### Wave Packet Structure

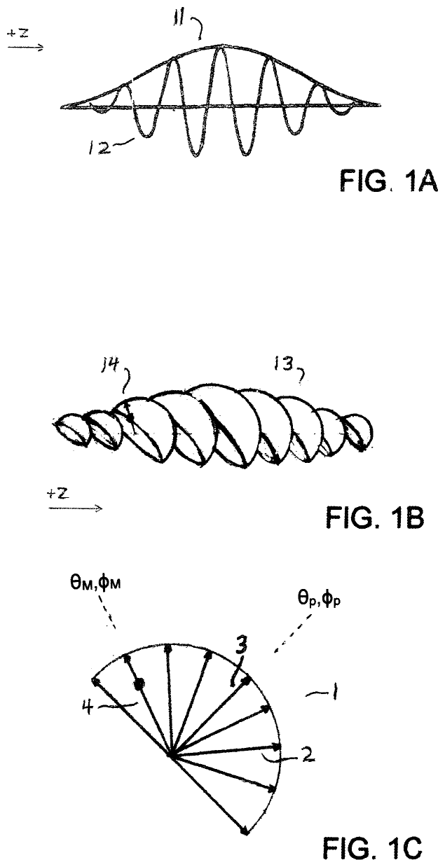

The detailed description of the invention is presented in the context of LR. For LR, FIG. 1A represents an incomplete one-dimensional representation of a continuum of physically real spin ½ structures along an electron wave packet showing only the probability envelope 11 of finding the particle-like entity at some point and the oscillatory amplitude 12 from which it is derived. FIG. 1B shows a sampling of these spin structures 13 along the FIG. 1A wave packet. For purposes of illustrative clarity in this disclosure, the three-dimensional wave packet distribution of spin structures is depicted only one dimensionally.

The spin structure continuum constitutes the underlying objectively real micro-structure of the FIG. 1A wave packet representation. The varying sizes depicting the samplings in FIG. 1B symbolically convey the relative local coherence density (wave intensity) of a particular sampled spin structure. Along the wave packet the phase factor of the FIG. 1A amplitude 12 is inherent in the FIG. 1B spin structures.

In LR, probability is computed from integrated wave intensity. The use of mathematical “probability” in LR is consistent with the analogous use of that term in PI. However, LR specifically excludes the existence of “probability waves” and “probabilistic entities”, quantities that from a PI perspective are either physically manifested or collapsed upon measurement. In LR, representations of entities such as radiation and matter have objective reality. Within that context many processes involving those entities are deterministic but some are not. A process in which an emitted entity has the orientation of a random member of an ensemble is an example of the latter.

FIG. 1C is a detailed selected cross sectional view transecting the hemisphere of a single spin structure in the continuum of spin structures within an entire wave packet. The hemispherical pole orientation of the depicted structure is θₚ,φₚ in spherical coordinates where the polar orientation measured from the +z axis is θₚ and the azimuthal angle of the hemispherical pole orientation in the xy plane is φₚ. For visual clarity, FIG. 1C depicts only several of the structure's spinors, e.g. 2, 3, and 4, that emanate radially and collectively define a cover set of a hemispherical surface 1. That hemispherical pole orientation θₚ,φₚ is common to the entire continuum of spin structures in a given wave packet.

Any random point along the wave packet would in general show an empty spin structure. However, for instructional purposes the FIG. 1C sampling uncommonly also includes the presence of the particle-like mass entity manifested as an excitation state on one of its spinors, 4 oriented at θ_{M},φ_{M}. That particle-like entity is represented by a solid dot on the spinor on which it resides. Additionally, for instructional purposes the selected FIG. 1C cross sectional view is inclusive of the particular occupied spinor at θ_{M},φ_{M} as well as the polar orientation of the spin structure at θₚ,φₚ.

For the particle-like entity of an electron, its characteristic mass is mₑ and it has a magnetic moment defined as the Bohr magneton μ_{B}=9.27×10⁻²¹ erg/gauss. In FIG. 1C the electron is shown as residing on spinor 4 oriented at θ_{M},φ_{M}. Effectively, the presence of the particle-like entity on a particular spinor constitutes an excited state of that “occupied” spinor 4. The particle-like excitation state migrates, mediated by quantum force with respect relative spin structure amplitude along the wave packet, to neighboring θ_{M},φ_{M} oriented spinors on the continuum of spin structures. In FIG. 1B, the particle-like electron is depicted on a particular spinor 14 of one of the wave packet's spin structures. In the interests of visual clarity, that (occupied) spinor 14 is the only spinor depicted on the entire wave packet of spin structures. Dynamically, the particle-like electron's charge −e and mass mₑ dominate the kinematics of the entire wave packet in reaction to external forces such as those associated with electric and magnetic fields.

In the LR representation the particle-like electron with its magnetic moment μ_{B} as well as the wave packet itself are objectively real entities. Important properties of that wave packet with respect to interactions with a magnetic field can be deduced from the Stern-Gerlach experiments, SGE [ref-3]. For example, in SGE the empty electron wave packet separated from the Ag atom continues through the SGE magnet at substantially the same velocity v as the deflected Ag atom which retains the occupied electron wave packet. That finite velocity v<c of the empty wave packet implies that it has a non-zero mass. By extension, the incident (occupied) wave packet and the separated occupied wave packet for the unpaired electron, both coupled to the Ag atom, would also have mass in addition to the mass of the particle-like electron residing on those wave packets. Those wave packet masses are necessarily very small compared to the mass mₑ of the particle-like electron and are postulated to be distributed in proportion to the respective objectively real probabilities of those wave packets.

### Magnets for Separation of Wave Packets

From the above analyses it can be deduced that magnets with axial field symmetry designed to demonstrate directional quantization of free electrons can be suitably modified for the LR objective of separating electron wave packets into occupied and empty wave packets. That objective can be extended to separation of wave packets for other particles by suitable scaling. For both of these magnet applications, DQ of free electrons and longitudinal polarization of beamed particle spins, LR separation of wave packets yields objectively real occupied and empty wave packets whereas PI forbids any objectively real separation of the wave packet. Short tubular magnets with collinear magnetic and geometric symmetry axes provide the requisite properties for wave packet separation and constitute essential components of the present invention. A longitudinal gradient field proportional to that of the SGE magnet along its beam path can be approximated by the axial gradient field magnitude of a short tubular magnet, despite the former having a transverse magnetic field and the latter having a longitudinal magnetic field and despite the very substantial differences in the geometries of the two magnets.

FIG. 2A shows a plane cross sectional view of a tubular magnet 14 where the field's symmetry axis is collinear to beam path 20-24 that includes distinctive segments alpha-numerically identified. Magnet 14 is a permanent magnet where the hatched region 14a represents the magnet shown in cross section. Alternatively, the short tubular magnet may be a solenoid electromagnet magnet 14 depicted in FIG. 2b which provides a similar axial gradient field to that of the permanent magnet in FIG. 2A. The hatched regions such as 14b represent cross sections of the windings of the solenoid coil.

Particle beams are directed along path 20-24. Particular segments of that path, 21a, 21c, 23a, and 23c, are located at inflection points of the longitudinal field magnitude. FIG. 2C is an approximate representation of the longitudinal magnetic field magnitude for the FIGS. 2A and 2B magnets showing the corresponding inflection point segments. Inflection points 21a and 23c occur approximately at a one radius distance R from the magnets where R is the magnet's mean radius.

FIG. 2C is marginally more representative of a FIG. 2A permanent magnet field than of a FIG. 2b electromagnet field to the extent that the former has a relatively negligible reversed magnetic field in the far field, i.e., along beam paths 20 and 24 at points >R from the magnet. In contrast, the corresponding far field of an electromagnet, such as that of FIG. 2b in beam paths 20 and 24, is positive relative to the field between those beam paths. More importantly with respect to DQ, the far field gradient magnetic field is negligible for permanent magnets as well as for electromagnets. Accordingly, the minor differences in far fields for permanent magnets and for electromagnets are similarly not of consequence with respect to DQ.

Axially, in the neighborhood of a distance ˜R from the magnet, 21a and 23c, there is a relatively sudden inflection of the magnetic field leading to a high magnetic field gradient that continues up to and marginally inside the magnet bore where there is a second relatively sudden inflection to a substantially constant axial magnetic field. The axial field within the bore continuing toward and beyond the distal magnet face is symmetric to that of the proximal face. In totality there are four sudden axial magnetic field inflections that proportionately approximate those of the SGE magnet.

Accordingly, with appropriate selection of magnet parameters, the magnitude and inflection points of tubular magnet's axial longitudinal magnetic field can closely duplicate the general features of the SGE magnetic field or be modified as necessary to achieve particular field values suitable to accommodate various particle types and velocities. For an electromagnetic solenoid, essential magnet parameters would principally include the coil geometry, the winding density, and the current. For a tubular permanent magnet, the essential parameters would principally include the magnet geometry and composition.

Fundamentally, the parameters for the requisite magnet, whether it is a permanent or electromagnetic, are designed to achieve or exceed the requisite magnetic gradient that induces DQ for a particular charged particle type and velocity. That DQ results in microscopic separation of the enriched (occupied) wave packet and the totally depleted (empty) wave packet but obviates the much more difficult requirement for macroscopically separating those wave packets, a requirement imposed for magnets demonstrating DQ.

A person having ordinary skill in the art will recognize that, that the geometrical criteria for a suitable magnet in the context of the present disclosure can be summarized as a “short tubular magnet” in the regard that an extended length of the magnet does not advantageously enhance the functionality of the magnet beyond the requisite microscopic separation of empty and occupied waves. Accordingly, a “short tubular magnet” is understood to mean a magnet length that is on the order of several mean radii.

The relevant suddenness threshold criterion for inducing directional quantization is, from the perspective of LR, functionally a threshold criterion for inducing condensation denoted as “Q”. Dynamically, for a particle moving at a velocity v=∂z/∂t the suddenness threshold criterion threshold criterion of an encounter with an increment of magnetic field resolves to some critical time rate of change of the magnetic field which is simply the product of the magnetic gradient and the velocity that minimally suffices to induce condensation,

Q=(∂B/∂z)(∂z/∂t)=∂B/∂t.

For whatever parameter values of magnetic gradient and velocity that mutually satisfy that threshold to induce condensation, moderate increases in one parameter accompanied by proportionate decreases in the other similarly still satisfy that Q criterion.

Within the limits of the reported specifications for SGE it can be deduced that a sufficient gradient for inducing directional quantization is

δ_{B}B˜10³ gauss/cm

so that for the 10⁵ cm/s velocity of the Ag atoms

Q=v∂_{y}B˜10⁵ cm/s×10³ gauss/cm˜10⁸ gauss/s.

### Parameters Critical to Separation and Achieving Those Parameters

An incident occupied wave packet is a physically extended structure which during a sudden and continued interaction with a substantial gradient undergoes a condensation process over some short but finite Δt_{c}, and continues in that condensed δ-form while traversing the remainder of the high gradient. The continued passage through the gradient can be modelled as repeated sudden significant ΔB interactions over sequential very short Δt intervals. At the very least for duality modulation separation to occur Δt_{c} must be less than the total interaction time Δtᵢ in which the particle wave packet transits the entire high gradient region.

The adverse converse condition ΔA_{c}>Δtᵢ occurs if v is too high and/or the high gradient length is too short. As a result, despite achieving Q on the gradient beam path, the condensation does not fully go to completion and the particle wave packet reverts back to its initial spatially extended wave packet within the magnet bore and does not undergo duality modulation separation.

From the perspective of LR the important insight to be gained from SGE is that duality modulation separation of a particle wave moving at a specified velocity requires both some threshold level of magnetic gradient to initiate that separation, i.e. achieving Q, and also some minimum time of continued interaction with that gradient to drive the condensation process to completion. If for example the minimum interaction time is not achieved, that deficiency can be corrected by modifying the magnet to provide the same gradient over a suitably longer distance. For a solenoid the modification might consist of increasing the coil diameter to proportionately lengthen the gradient length and to concurrently increase the coil current to maintain the gradient magnitude.

Satisfactory parameters for obtaining separated duality modulated wave packets from a particular axially symmetric tubular magnet for various particle types and velocities can be approximated from parameters deduced from SGE taking into account that the particles in those two experiments are atomic orbital electrons and are not free electrons or other types of free particles. As a practical matter, the parameters applicable to free particles can systematically be determined by polarimeter measurement techniques well known in the art. For example, an input particle type and a single magnet such as that depicted in FIG. 2A or FIG. 2b are configured with a polarimeter on the beam output path. The particles on the input beam have random orientations and some selected velocity v. A multiplicity of polarimeter orientations are used to fully characterize the components of beam polarization from elastic scatterings in the polarimeter.

If the polarimeter measurements show that the output particles are axially polarized, the particle velocity should be reduced to the level at which that axial polarization vanishes. The velocity marginally above that level provides the requisite threshold velocity parameter, in conjunction with the existing magnet parameters, for the objective of duality modulation separation. (Axial polarization means that statistically there is a cos² θ distribution of polarimeter-measured spin orientations at θ relative to that axis.)

Alternatively, if the polarimeter measurements show that the output particles are not axially polarized, the particle velocity should be increased to the level at which the axial polarization occurs to establish that requisite threshold velocity parameter.

It is noted that “spin precession solenoids” are used in the art to produce axial alignment of particle polarization. These solenoids adiabatically rotate the particle spin to the axial direction by the magnetic field interior to their bores as the particles transit the length of the bore. Moreover, the spin precession solenoids, equipped with ferromagnetic shields, reduce the normal fringe field exterior to the solenoid to negligible values. In place of that normal fringe field there is a near step-function gradient with a particle transit time across that extremely abrupt “gradient” shorter than the particle wave packet condensation time. Accordingly, such spin precession solenoids do not generate duality modulation separation. The duality modulation separation methods disclosed here employ sudden, non-adiabatic processes that are dependent upon the product of the particle velocity and the magnitude of the magnet's largely exterior gradient magnetic field.

The specific magnetic field conditions for achieving axial polarization are distinctly different with respect to spin precession solenoid methods and duality modulation separation methods. Consequently, when beam polarimetry indicates axial polarization, the specific magnetic field conditions can be used to confirm that the method is that of duality modulation separation and, by implication, that the occupied wave packets are accompanied by empty wave packets.

### Pulsed Magnet Applied to Stationary Wave Packets

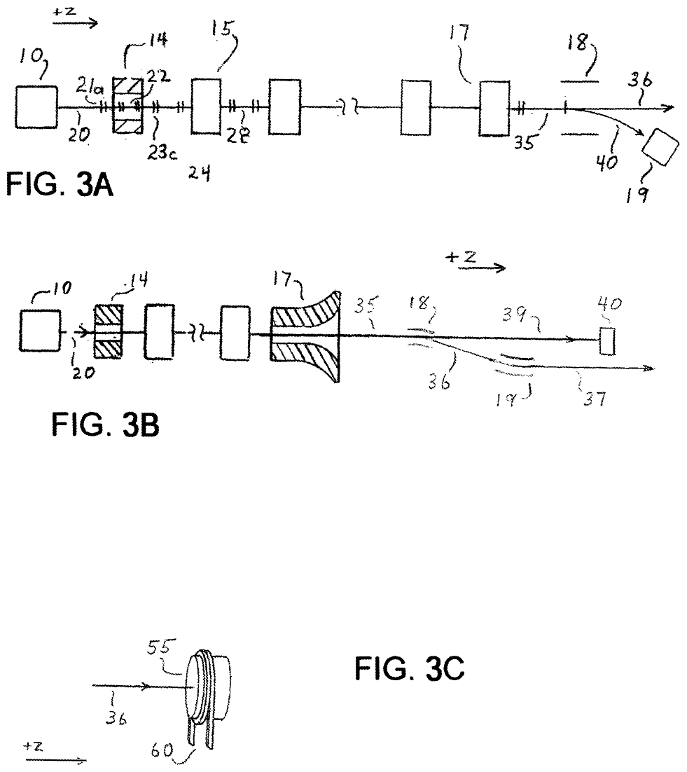

FIG. 3c depicts a solenoid coil 60 encircling stationary particles in 55. (55 may consist of a solid mass of a single atomic species where the relevant stationary particles are the nuclei of that atomic species. Beam 36 relates to non-stationary particles that might be incident on 55.) When a brief impulse current is provided to coil 60 the axial magnetic field within 55 rapidly increases over a brief time interval. During that time there is a transient temporal longitudinal gradient ∂B/∂t within the solenoid coil 60 along the coil's symmetry axis where stationary particles in 55 are situated. By providing a sufficiently sudden increase in that temporal gradient, ∂B/∂t=Q, the threshold criterion for condensation of the stationary particle wave packets. The resultant condensation drives the stationary particle wave packets to an occupied δ-form spinor and an empty contiguous complementary δ-form spinor. The two spinors are anti-aligned to each other and are aligned with the longitudinal symmetry axis of the solenoid coil 60. Importantly, that transient axial alignment of the stationary occupied δ-form spinors is consequential in enhancing collision interactions with beam 36 axially aligned particles.

Since the stationary particle wave packets are physically constrained at points along that symmetry axis, the transient temporal gradient does not longitudinally displace the occupied δ-form spinor relative to the empty δ-form spinor as it would for similar free anti-aligned occupied and empty δ-form spinors. Accordingly, after the dissipation of the transient temporal gradient, the stationary anti-aligned δ-form spinors resolve back to the original wave packet of the stationary particle and there is no persistent duality modulation separation of the stationary particle wave packet.

### An Example of a Suitable Permanent Magnet

A suitable permanent magnet approximately meeting SGE directional quantization sufficiency criteria can be provided by an N52 Neodymium “ring” magnet with a 2 cm O.D, a 0.4 cm inner diameter and a 0.4 cm thickness. Axially that magnet has a ˜0 to 7200 gauss field increase over a 0.35 cm span representing a 2×10⁴ gauss/cm gradient. A similar field can be generated with a solenoid with similar geometrical dimensions and a current supply. With regard to achieving sufficiency criteria, permanent magnets are generally preferred for applications disclosed here that are compatible with steady state magnetic fields. However, solenoids provided with a pulsed current source that can rapidly be ramped up or down, can temporally simulate to physically stationary “target” particles situated within its bore the transit of beamed particles through a gradient field.

Importantly, the sufficiency criteria for suddenness that results in directional quantization is functionally dependent upon the time rate of change of the magnetic field dB/dt experienced by the occupied wave packet. For a given magnetic field gradient that quantity is linearly dependent upon the velocity of the occupied wave packet. Then for sufficiency criteria for suddenness deduced from SGE, where the effective velocity of the Ag unpaired electron is ˜10³ m/s, that criteria is far exceeded if the velocity of free electrons in a similar gradient magnetic field is several orders of magnitude higher. If for those higher velocities, the transit time through the high gradient region is too brief to adequately separate the complementary δ-form spinors, the transit time in the gradient must be increased. That objective is readily achieved by modifying the magnet such that the length of the relatively high axial gradient exterior to the magnet face is increased while concurrently maintaining a gradient for condensation. Methods for implementing the requisite magnet modifications are well known in the art.

As noted above in this disclosure, the invention only requires a microscopic longitudinal separation of the two spinors since they are subsequently totally separated by electromagnetic means. Nevertheless, if even a satisfactory microscopic separation is not achieved as a consequence of rapid passage out of the gradient region, the two substantially contiguous δ-form spinors will resolve back together in the process of evolving back to a spin structure and no empty spin structure will be generated. Accordingly, there is effectively a temporal “window” of requisite residence in a high gradient region. That time must be short enough to provide a sufficiently sudden onset of a substantial magnetic field to induce condensation but must be long enough to microscopically separate the resultant complementary contiguous δ-form spinors.

### Duality Modulation Separation of Free Charged Particle Wave Packets

The following analysis is given for the example of a particle beam comprised of free electrons. The analysis for other particles of interest, typically light nuclei such as protons, is similar despite the differences in charge and mass. Accordingly, the satisfactory magnetic field parameters and particle velocities for different particle types are correspondingly different but the general designs of the different apparatus configurations for achieving the duality modulated particle separations are substantially similar.

The magnet configurations such as those depicted in FIGS. 2A, 2B, 3A, and 3B are necessarily situated in a vacuum. The empty wave beam generated by those configurations can be efficiently transmitted through an appropriately transmissive window in a vacuum containment vessel whereupon it can be directed through atmosphere if necessary to a remote target. The window is optimally composed of a non-conductive material in which equilibration of the empty waves with electrons in that material is negligible.

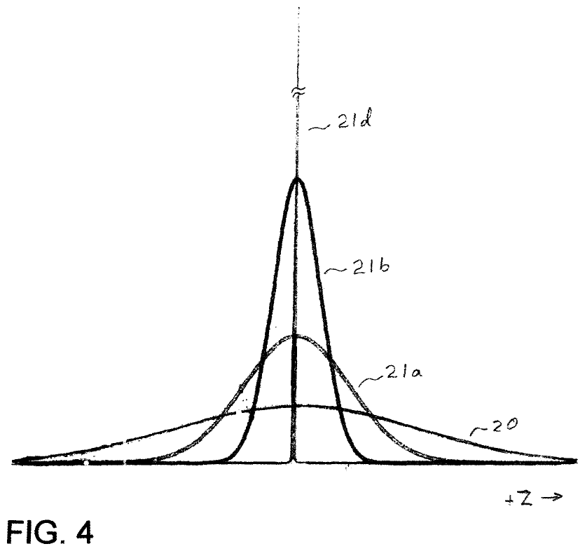

FIG. 4 illustrates the progressive condensation of a free particle's wave packet sudden entry into a high gradient magnetic field. The initially unperturbed wave packet envelope 20 progresses through intermediate condensation stages depicted by envelopes 21a and 21b, ending with a δ-form spinor envelope 21d. Probability, which is the integral of the wave intensity over the entire envelope, is conserved in this condensation process. The condensation process then rapidly evolves back to an occupied extended wave packet represented approximately by probability envelopes 21b→21a→20. That representation is approximate because a fraction of the probability on 21d is separated by the presence of the gradient field and evolves back to an empty extended wave packet.

### Representations of Wave States on Magnet Beam Paths

In the analysis below wave packet states along magnet beam paths are first considered for single magnets such as those depicted in FIGS. 2A and 2B. From that analysis, output wave states from cascades of single magnets, as in FIGS. 2C and 2C-a are deduced.

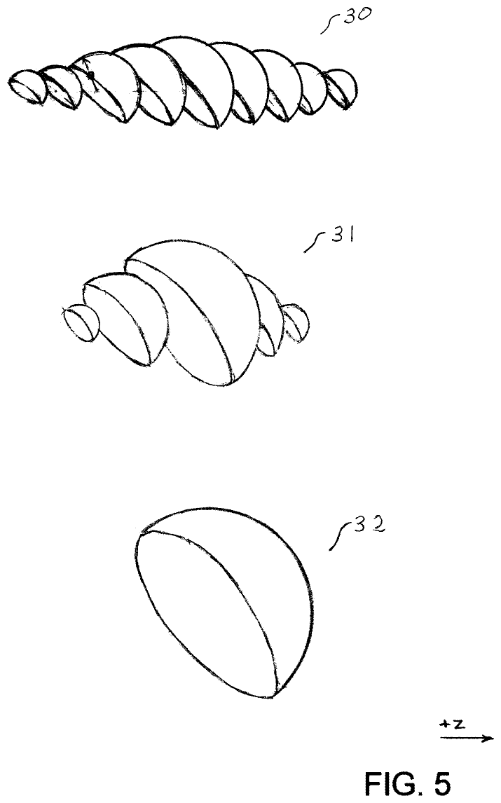

The representations of the wave packets by their probability envelopes as in FIG. 4 only partially describes the underlying mechanism of directional quantization and the production of empty wave packets. The linear trajectory in FIGS. 2A and 2B is divided into numbered segments. FIG. 5-FIG. 10 depict the representative LR quantum states at each of these segments for an example of a particular electron emitted by source 10 as it progresses into each successive segment. The wave packets of electrons emitted by source 10 are assigned a normalized probability P=1. In the processes that follow as wave packets progress along successive segments, probability is conserved.

For segment 20 of the linear trajectory in FIGS. 2A and 2B, the example of a particular electron emitted by beam source is chosen to have a polar orientation of its spin structures at some θₚ<90° (as opposed θₚ>90°) where the +z axis of the spherical coordinate frame is aligned with the propagation direction of electrons emitted by the source.

The example of that particular θₚ<90° spatially extended wave packet on segment 20 is depicted in FIG. 5 correspondingly identified by 20. For purposes of illustrative clarity, the 3-dimensional wave packet distribution of spin structures is depicted one-dimensionally along the z axis.

The magnetic moment μ_{B} of the particle-like electron resides on one of the spin structures on a spinor that has some orientation θ_{M} which is generally distinct from the common orientation θₚ of that spin structure and the other spin structures of the wave packet.

It will be clearly demonstrated, however, that in the presently considered example of θₚ<90° for the spin structures, a “measurement” of the spin state of the wave packet, as in a SGE, deterministically yields a “spin up” measurement result with μ_{B} on the 0° spinor even if the initial spinor on which μ_{B} had resided had an orientation θₚ>90° as shown for example on the FIG. 5 occupied wave packet 30. (Alternatively in the foregoing, if the spin structure orientations of the particular electron emitted by source 10 had been θₚ>90° instead of θₚ<90°, a “spin down” measurement would result.)

In FIGS. 2A and 2B the short segment 21a corresponds to an inflection region in which the magnetic field suddenly transitions from a negligible field to an abruptly increasing field. As a result, the quantum state of a spatially extended electron wave packet leaving segment 20 and entering segment 21a experiences a sudden onset of a substantial magnetic field. For the presently considered magnet 14 in FIGS. 2A and 2B, the axial magnetic field vector B is directed along the z-axis in the direction opposite the direction of the beam.

The sudden rise of a substantial magnetic field in segment 21a produces a high magnetic gradient that causes the initially extended electron wave packet of spin structures 30 in FIG. 5 to “spatially” condense. This condensation is represented in an intermediate stage by 31, followed by reduction to a single spin structure 32. Probability is conserved in this process.

Accompanying that “spatial” condensation process of the spin structures there is a concurrent “projective” condensation process that occurs on the spin structures themselves. In that process the spinors associated with each spin structure projectively condense along the magnetic field axis ±B that intersects the spin structure.

In the following analysis of condensation processes, the extreme case of the spatial condensation proceeding entirely to completion to a single spin structure 32 is depicted in the FIG. 5 progression of 30→31→32 before treating, below, the concurrent projective condensation of the spin structures themselves. This “sequential representation” is contrary to the general case of the spatial and projective condensation processes proceeding concurrently but is utilized here for the purposes of more clearly distinguishing the two processes. A person having ordinary skill in the art will recognize that, in the final analysis that the relative temporal progression of those two processes does not alter the outcome of a single occupied δ-form spinor accompanied by a single empty δ-form spinor.

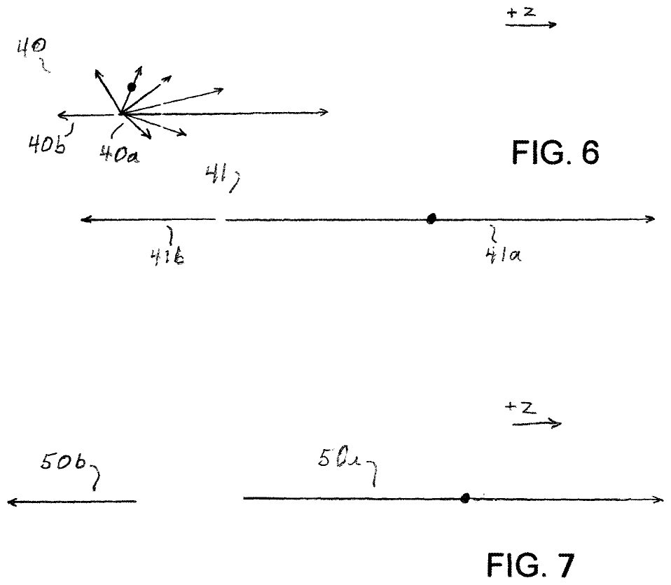

The intermediate phase of the projective condensation is depicted on a typical spin structure 40 in FIG. 6. At that intermediate phase, the spin structure 40 has begun to split into a partially projectively condensed spin structure 40a and a contiguous anti-aligned orthogonal δ-form spinor 40b. Spin structure 40 might correspond to any one of the spin structures on the wave packet 31 in FIG. 5. However, in the FIG. 6 depiction the otherwise typical spin structure 40 untypically happens to include for instructional purposes the particle-like electron located on 40a. Notably, compared to the spinor orientation of the particle-like electron in wave packet 30 of FIG. 5, the particle-like electron on 40a of FIG. 6 has migrated to a spinor more closely aligned to the projective condensation axis of 40a. That orientation migration is caused by quantum forces associated with the projective condensation whereas the orientation migration is not associated with the spatial condensation.

For the presently considered example of a particular electron wave packet approaching segment 21a in FIG. 2A and 2B, the electron wave packet has spin structures with an objectively real polar angle θₚ<90° (rather than >90°). This distinction does not impact the condensation of the physically extended wave packet to a single occupied spin structure, but it does critically relate to the directional quantization outcome of the projective condensation process that promptly follows.

Because the spin structure 30 in FIG. 5 has an orientation θₚ<90°, the spin structure is intercepted by the magnet's B field vector along its 0°-oriented spinor. In a process that is analogous to photon interactions with a calcite polarization axis, [ref-2], the spinors of that single spin structure projectively condense along that 0° spinor as shown by the transitional state on 40a depicted in FIG. 6. In further analogy to those photon interactions, a complementary orthogonal projective condensation process occurs along the 180° orientation as shown in transition on 40b contiguous to 40a.

The underlying physical mechanism of the directional quantization itself is represented in LR by the computation of the quantum force from Schrodinger's equation confluent to the spin structure surface. In the state depicted on 40a the quantum force associated with that sharply peaked redistribution of spinors along the 0° spinor is shown to have rotated the particle-like electron and its associated magnetic moment μ_{B} from its original spinor on 30 of FIG. 5 to a new orientation on 40a of FIG. 6 more closely approaching the projectively increasing 0° spinor.

The projective condensations are shown to completion on 41 of FIG. 6 where the single remaining spin structure, 32 on FIG. 5, has resolved to single occupied spinor 41a at 0° and a contiguous complementary empty spinor 41b at 180°. Spinor algebra demonstrates that the projective condensation of the original θₚ-oriented spin structure results in the single occupied spinor 41a having a probability P=cos²(θₚ/2). The complementary empty spinor 41b is similarly shown to have P=sin²(θₚ/2) demonstrating that probability is still conserved in the projective condensation process in further analogy with photon wave packet splitting at a calcite polarizer. [ref-2]

Following the sudden rise of a magnetic field that produced the condensation process in segment 21a FIG. 2C, the contiguous 41a and 41b FIG. 6 “δ-form” spinor states enter the subsequent segment 21b where the magnetic field continues to rise producing a high magnet gradient over the length of that segment.

As with the longitudinal fringe field gradient exterior to the SGE magnet, the passage of an electron wave packet through the segment 21b FIG. 2C gradient can be modelled as repeated sudden significant ΔB interactions over sequential very short Δt intervals. As a result, the contiguous 41a and 41b FIG. 6 projectively condensed δ-form spinor states exiting segment 21a remain as projectively condensed δ-form spinor states respectively 50a and 50b on FIG. 7 throughout their transit of the high gradient segment 21b, FIG. 2C.

Notably, the δ-form spinors 50a and 50b on FIG. 7 are non-contiguous, longitudinally separated and that separation. That separation, which increases over the transit of segment 21b, FIG. 2C. The particle-like electron's magnetic moment vector μ_{B} on the occupied δ-form 0° spinor 50a is itself oriented oppositely toward 180°. Since the magnetic field vector B is also oriented toward 180°, the gradient force on the occupied δ-form 0° spinor 50a, F=μ_{B}·∂_{z}B, accelerates that occupied δ-form spinor along +z. However, there is no gradient force on the complementary empty δ-form spinor 50b. As a consequence, the two δ-form spinors 50a and 50b are progressively separated longitudinally by the acceleration of 50a.

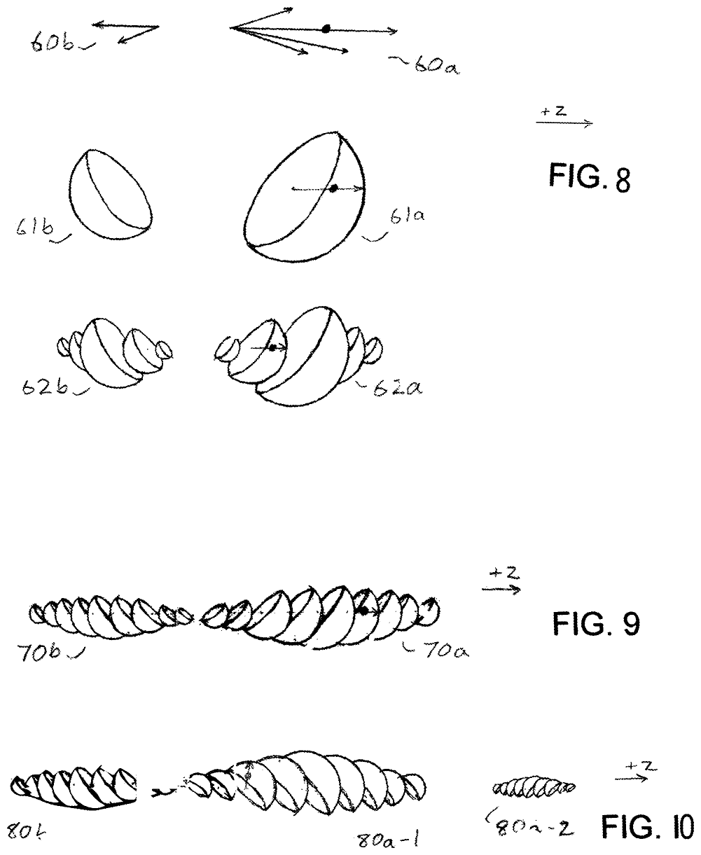

The high gradient segment 21b, FIG. 2C transitions to segment 21c characterized by an inflection in the magnetic field in which the gradient magnitude falls below the threshold criterion for condensation. FIG. 8 depicts the evolution of the two δ-form spinors back toward two respective wave packets of spin structures, beginning with transitional spin structures 60a and 60b.

Notably for the occupied δ-form spinor 60a, the evolution of that δ-form spinor back to a spin structure would ordinarily result in quantum forces perturbing μ_{B} onto one of the forming spinors. However, because of the continued presence of a substantial B field, the particle-like electron and its magnetic moment μ_{B} remain on the 0° spinor of the evolving spin structure as shown on 60a. Importantly, the continued presence of μ_{B} on that 0° spinor constitutes the directional quantization result that is deterministically set by the present example of an incident electron wave packet oriented at some θₚ<90°.

The longitudinally separated transitional spinor states 60a and 60b initially evolve to single spin structures as depicted in FIG. 8 by the respective examples of the occupied spin structure 61a and the empty spin structure 61b. The particle-like electron and its magnetic moment μ_{B} are located on the 0° spinor of the occupied spin structure 61a. That occupied spin structure 61a has a polar orientation designated θₚ₋₂ that is generally different from the incident θₚ but similarly that θₚ₋₂<90°. In close analogy to photon wave packet emergence from polarizers, [ref-2], θₚ₋₂ is the orientation of a random member of a 0°-polarized ensemble of electron wave packets. Similarly, the empty wave spin structure 61b has the orientation θₚ₋₃ of a random member of a 180°-polarized ensemble of electron wave packets (resulting in θₚ₋₃>90°) but lacks the particle-like electron and its magnetic moment. The occupied spin structure 61a and the empty spin structure 61b each evolve into transitional coherent spin structure wave packets respectively represented by 62a and 62b.

The evolution process is shown to completion as those transitional wave packets emerge from segment 21c of FIG. 3A and enter segment 22 of FIG. 3A as the FIG. 9 respective extended wave packets 70a and 70b. In this evolution process, the respective polar orientations of occupied and empty spin structures are maintained relative to those of 62a and 62b. Additionally, the particle-like electron and its magnetic moment μ_{B} continue to reside on a 0° spinor of a spin structure but are not otherwise constrained to that particular spin structure. As already noted in this disclosure, on a coherent wave packet of spin structures the particle-like electron and its magnetic moment μ_{B} residing on a spinor at θ_{M},ϕ_{M} of a spin structure migrates to at θ_{M},ϕ_{M} spinors of neighboring spin structures as a function of the local probability envelope of the wave packet. In the present case of the occupied wave packet 70a that migration still maintains the directional quantization θ_{M}=0° but, because of the longitudinal magnetic field on segment 22 of FIG. 3A, Larmor precession changes the azimuthal ϕₚ of the spin structures themselves and migration of μ_{B} to the spinor at the same relative ϕ_{M} is correspondingly amended to be in compliance with respect to the spin structure frames.

The additional velocity acquired by the occupied wave packet 70a while in the gradient of segment 21b causes it to further separate from the empty wave packet 70b while in the non-gradient segment 22. The magnitude of the separation attributable to this region is proportional to the length of segment 22 which is nearly the magnet's entire bore length.

When the two wave packets 70a and 70b approach the end of the magnet bore and enter onto segment 23a located at a magnetic field inflection, the magnitude of the longitudinal gradient increases to the threshold level that induces condensation.

As a result, the occupied wave packet of spin structures 70a on segment 22 condenses in segment 23a to a contiguous pair of δ-form spinors, an occupied δ-form spinor denoted as 70a-1 and an anti-aligned empty δ-form spinor denoted as 70a-2, neither illustrated. This condensation process is equivalent to the condensation process on segment 21a. From spinor algebra, the probability of the occupied δ-form spinor 70a-1 is cos²(θₚ/2)cos²(θₚ₋₂/2) and the probability of the empty δ-form spinor 70a-2 is cos²(θₚ/2)sin²(θₚ₋₂/2) showing that the probability cos 2 (θₚ/2) of 70a is conserved.

The empty wave packet 70b, with a θₚ₋₃>90°, that follows the occupied wave packet 70a into segment 23a similarly condenses to a pair of contiguous anti-aligned δ-form spinors denoted as 70b-1 and 70b-2, both of which are necessarily empty and neither is illustrated. In that process, the probability sin²(θₚ/2) of 70b is split into sin²(θₚ/2)sin²(θₚ₋₃/2) for 70b-1 sin²(θₚ/2)cos²(θₚ₋₃/2) for 70b-2 showing that the probability sin²(θₚ/2) of 70a is conserved.

The two pairs of contiguous δ-form spinors exit segment 23a and enter the high magnitude gradient segment 23b. The outcome for the 70a-1 and 70a-2 contiguous pair is largely similar to that of 41a and 41b contiguous pair considered above. The 70a-1 and 70a-2 contiguous pair enter the high magnitude gradient segment 23b that longitudinally separates the two δ-form spinors by decelerating the 70a-1 occupied δ-form spinor since the segment 23b gradient is reversed relative to the segment 21b gradient. The 70a-2 empty δ-form spinor and the trailing occupied 70a-1 δ-form spinor enter segment 23c located at a magnetic field inflection where both evolve toward wave packets of spin structures that emerge onto the negligible magnetic field of segment 24 as normally extended wave packets 80a-2 and 80a-1 in FIG. 10, respectively.

Because the magnetic field B reduces to a negligible value in the distal part of segment 23c, the energy represented by μ_{B}B is also negligible and the evolving spinors of 70a-1 forming a new spin structure, in an evolution process reversing projective condensation, readily perturb μ_{B} away from the 0° spinor erasing the explicit directional quantization that had been present on the preceding δ-form spinor 70a-1. Accordingly, the wave packet 80a-1 in FIG. 10 is depicted as non-directionally quantized. (In contrast, the wave packet 70a in FIG. 9 is depicted as directionally quantized because of a substantial magnetic field present as the evolution process leading to that wave packet occurred.)

The outcome is somewhat different for the empty wave packet 70b that condenses to the pair of empty contiguous anti-aligned δ-form spinors 70b-1 and 70b-2, neither illustrated, which enter onto the high gradient segment 23b. Because both of the δ-form spinors are empty, neither is subjected to a gradient-induced acceleration and the two δ-form spinors remain in an anti-aligned contiguous state as they transit segment 23b and enter segment 23c located at a magnetic field inflection. Because of their continued contiguity, the wave packet evolution process in segment 23c resolves the two δ-form spinors back to a single wave packet 80b on segment 24 as that shown in FIG. 10. That empty wave packet 80b replicates the empty wave packet 70b in FIG. 9.

In summary for the specific case an occupied θₚ<90° electron wave packet with probability P=1 traversing magnet 14, FIG. 2A or 2B, there is a splitting of that occupied wave packet onto segment 24 of an empty wave packet 80a-2 with probability P=cos²(θₚ/2)sin²(θₚ₋₂/2) followed by an occupied wave packet 80a-1 with P=cos²(θₚ/2)cos²(θₚ₋₂/2) and followed by an empty wave packet 80b with P=sin²(θₚ/2) as shown in FIG. 10.

Most generally however, the above analysis for a single magnet teaches that the substantial consequence of an occupied particle wave packet traversing a magnet of the type disclosed results in an output such as that shown in FIG. 10 consisting of a relatively enriched wave packet accompanied by a two empty wave packets, one leading and one trailing, where the probability deficit of the enriched wave packet resides on the two empty wave packets. As an ancillary matter, with regard to the small non-zero masses of the wave packets being proportional to their respective probabilities, where the mass of the incident electron wave packet is m_{w}<<mₑ, the respective masses of the wave packets in FIG. 10 are m_{w} sin²(θ/2) for 80b, m_{w} cos²(θₚ/2)cos²(θₚ₋₂/2) for 80a-1 and m_{w} cos²(θₚ/2)sin²(θₚ₋₂/2) for 80a-2.

### Cascade Configurations

From the above analysis of output from a single magnet “stage,” it can be deduced that a cascade configuration of such magnets can advantageously provide increased enrichment of an occupied particle wave packet and an increased number of empty wave packets.

The FIG. 3A configuration illustrates a cascade of a multiplicity of such magnets. Source 10 provides a beam 20 of free charged particles such as electrons or atomic nuclei such as protons moving at some selected velocity. Beam 20 is re-identified as beam segment 21a proximal to a first magnet 14 shown in cross section in this figure and in FIG. 2A. In both of those figures, magnet 14 is depicted as a permanent magnet but in general that magnet and other magnets depicted in the figures can be either solenoid electromagnets, such as that depicted in FIG. 2b, or permanent magnets, unless specified to the contrary.

From the analysis of the output of a single magnet, such as 14 in FIG. 3A. After those three wave packets traverse a successive magnet 15, functionally equivalent to magnet 14, on segment 28 there is a further enriched wave packet accompanied by a four empty wave packets, two leading and two trailing, where the increased probability deficit of the enriched wave packet resides on the four empty wave packets. All of those five wave packets are mutually longitudinally separated as a consequence of the longitudinal gradients of the magnets accelerating and decelerating the occupied wave packet from which the empty wave packets are extracted.

A final magnet 17 is depicted with an output to a beam segment 35. If the total number of magnets is N, for every particle wave packet input on beam 20 there is on segment 35 a substantially enriched wave packet accompanied by 2N empty wave packets, N leading and N trailing, where the probability deficit of the substantially enriched wave packet resides on the 2N empty wave packets. All of these 2N+1 wave packets are mutually longitudinally separated on segment 35.

For an application utilizing the highly enriched particle wave packet where accompaniment by the 2N empty wave packets does not adversely affect that application, the FIG. 3A configuration provides a suitable output with the electric field deflection plates 18 inactive or eliminated.

For an application utilizing the 2N empty wave packets the electric field deflection plates are activated whereby the highly enriched particle wave packet is deflected onto beam segment 40 and the 2N empty wave packets continue from beam segment 35 to output beam segment 36. For that activation, opposite charges are supplied to the respective two opposing deflection plates 18 depicted on edge. Means 19 minimally serves as a beam stop for the highly enriched particle wave packets and can additionally serve as a means to recapture the energy of that wave packet.

For an instantiation utilizing the highly enriched particle wave packet where accompaniment by the 2N empty wave packets does adversely affect that application, the FIG. 3B variant of the FIG. 3A configuration provides a suitable output with the two sets of electric field deflection plates 18 and 19 activated. By these means, the highly enriched particle wave packet is first deflected onto beam segment 36 and then onto output beam segment 37 in parallel displacement relative to the principal beam axis of the configuration. Concurrently, the 2N empty wave packets continue from beam segment 35 onto beam segment 39 where they can be absorbed by a beam blocker 40.

In particular applications utilizing a highly enriched particle wave packet it is advantageous to have the beamed particle's magnetic moment aligned with the magnetic field axis. This alignment capability can be provided by a divergent bore tubular magnet such as 17 in FIG. 3B.

In applications where it is advantageous to have the beamed particle magnetic moments aligned with the magnetic field axis, it is generally additionally advantageous to have stationary “target” particles such as nuclei to similarly have their magnetic moments aligned with the magnetic field axis. That complementary alignment capability for target particles is depicted in FIG. 3c which shows a projective view of an electromagnet coil 60 encircling axially-located stationary target nuclei 55. An impulse current to the coil provides for a temporal magnetic gradient on the nuclei that induces condensation of the target nuclei to δ-form axial alignment in synchrony with impact of beamed particles similarly in axial alignment.

Conversely, when that alignment capability is not advantageous, 17 in FIG. 3b can be replaced with another magnet of the same type as that used in its magnet cascade. When accompaniment of the highly enriched particle wave packet by 2N empty wave packets is not detrimental to those particular applications, the divergent bore tubular magnet 17 in FIG. 3b can be substituted for the non-divergent 17 in FIG. 3A.

The divergent bore tubular magnet achieves magnetic moment alignment by reducing the magnet's output gradient below the relevant Q value for condensation. As a result, the z axial magnetic moment alignment present when the particle wave packet is approximately midway through the magnet bore is retained because of the subsequent non-sudden, gradual decrease in the magnetic field and its gradient as the wave packet proceeds further through and out of the bore and continues distal to the magnet. In that process, the occupied wave packets are effectively “super polarized” specifically with regard to their magnetic moments having orientations with z axis alignment but not with respect to the orientations of their spin structures which exhibit a polarization ensemble distribution of orientations.

The divergent bore of a tubular magnet illustrates one particular magnet design that achieves the requisite gradual decrease in the magnet's output field results in super polarization of magnetic moment orientations. That requisite gradual decrease in the magnet's output field can alternatively be provided by other magnet designs such as a (non-divergent) tubular magnet followed by a proximal (non-divergent) tubular magnet with a larger bore diameter. That requisite gradual decrease can also be temporally provided in a solenoid such as in FIG. 2b by reducing the coil current as a particle wave packet in transit is within the magnet bore. Fundamentally, the novel capability of generating super polarization of magnetic moments is derived from providing a requisite gradual decrease in the output magnetic field and is not constrained by a particular magnet design that provides that requisite gradual decrease. The essential criterion resolves to reducing the magnitude of the longitudinal gradient ∂_{z}B below the threshold for condensation of a particular particle type moving at a particular velocity. This is applied from a point along the axial magnetic field within the magnet bore where the field is relatively constant to a point on the beam path distal to the magnet output where the field is negligible.

Magnetic moment super polarization provides an additional method, a diagnostic aid, for verifying that duality modulation separation is occurring. Polarimeter measurements of the beam output from a magnet with the requisite gradual decrease in its output magnetic field shows spin components negligibly deviating from the z axis. In contrast, for a symmetrical input/output field as from the FIGS. 2A and 2B magnets, the output particle wave packets collectively show a distribution of spin components consistent with a polarization ensemble of spin orientations about the z axis.

A divergent bore magnet, such as 17 depicted in the FIG. 3b, or the functional equivalent of that magnet may be used in replacement of the non-divergent magnet 17 in the FIG. 3A configuration for applications of enriched wave packets requiring axial alignment of magnetic moments that are not-adversely affected by the concurrent presence of empty wave packets.

The outputs from a final magnet of a magnet cascade configuration such as depicted in FIG. 3A can be quantified by a statistical analysis performed over an ensemble distribution. When an occupied wave packet emerges from magnet such as that depicted in FIG. 2A the spin structures all have a common polar orientation θₚ that is the orientation of a random member of a polarization ensemble. A computation based upon the distribution of orientations for those members determines the statistical projective condensation splitting of probabilities when that wave packet encounters a sequential magnet. The analogous computation given in [ref-2] for photons is applicable in the present case for particles. In the present context that splitting is directly relevant to occupied wave packets encountering a magnet since the gradient force at the input end of the magnet physically separates the transitional occupied wave structure from the transitional empty wave structure.

If the source 10 FIG. 3A wave packets with P=1 are polarized relative to the z axis, the statistical average value of the separated occupied wave packet probability for magnet 14 onto segment 22 in the magnet bore computed over the ensemble distribution is <P>=<cos²(θ/2)>=0.89. [ref-2] The complementary statistical average of the empty wave packet probability on segment 22 is then 0.11 of the incident P=1 wave packet, i.e. <P>=(1)(0.11)=0.11. When that occupied wave packet transits the remainder of the magnet 14 the average probability of the occupied wave packet emerging onto segment 24 is then <P>=0.89² and the average probability of the newly separated empty is <P>=(0.89)(0.11). Additionally, the empty wave packet on segment 24 with <P>=0.11 is substantially transmitted through the remainder of magnet 14 onto segment 24, still with <P>=0.11 and a >90° polar orientation although that polar orientation is not in general the same as it was on segment 22.

These results are readily extrapolated to the FIG. 3A sequence of N magnets. The average probability of the occupied wave packet emerging from the N th magnet onto segment 35 is <P>=0.89^{2N}. The total average probability of empty wave packets extracted from the incident P=1 wave packet is <P>=1-0.89² N. Beginning with the first extracted empty wave packet those 2N empty wave packets have average probabilities <P>=0.11, (0.89)(0.11), (0.89)²(0.11), (0.89)³(0.11), . . . (0.89)^{2N}(0.11).

For N=10 magnets, 90% of the initial electron wave packet probability is extracted onto the resultant 20 empty wave packets. The final occupied wave packet emerging from the 10^{th} magnet has an average probability <P>=0.1 and is characterized as highly “enriched” in reference to the ratio of the particle-like electron relative to the highly reduced probability of the wave packet on which it resides.

### Communications Applications

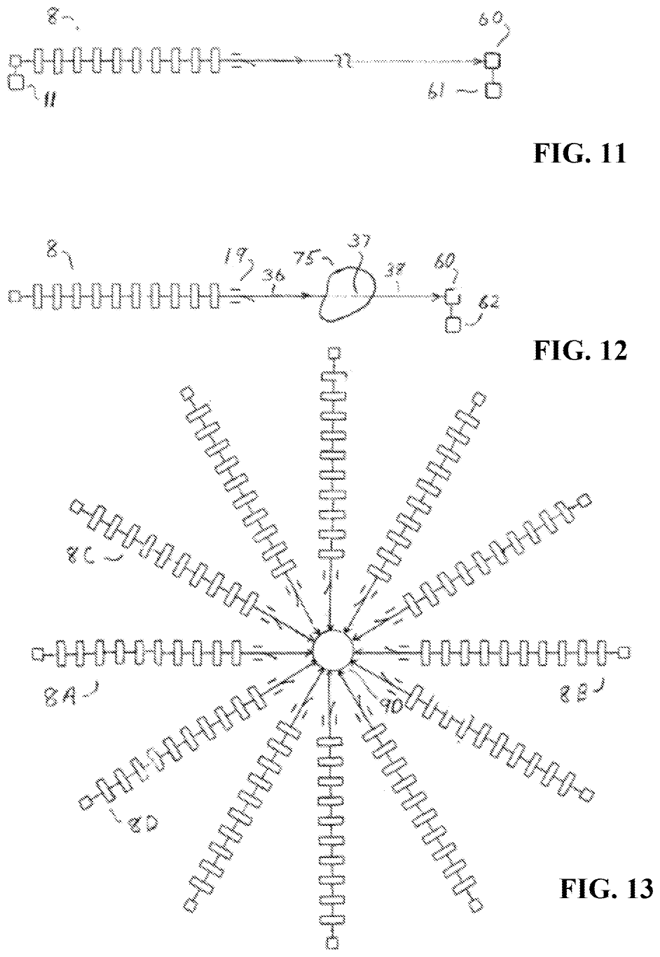

The empty wave packets can be utilized for free-space communication. In this capacity, the FIG. 3A configuration represented in FIG. 11 as 8 further includes a modulator 11 that encodes a communication signal onto the output beam of the configuration 8 source, a distal detector 60 to detect the empty waves and an associated signal analyzer 61 to demodulate the encoded signal. Modulator 11 encodes the signal by conventionally modulating the output of the electron beam source which results in the empty wave beam having that same modulation.

Conventional charged particle detectors are substantially unresponsive to empty waves. These conventional detectors function by measuring the ionization energy deposited by charged particles as they traverse the atomic structure of the detector. Measurement of empty waves requires a particular class of detectors that utilize quantum tunneling in providing an output signal.

There are several well-known semiconductor devices that fall into this category. These include Esaki tunnel diodes and tunneling field effect transistors. In the conventional use of these devices when incorporated into a circuit having an input and an output, different input signals produce differentiated outputs as a result of the inherent tunneling characteristics of an individual device. In this manner, such tunneling devices effectively function as detectors of particular input signals.

This functionality is reversed in the present invention for purposes of adapting such devices as detectors of empty wave packets. In that application, the tunneling characteristics of an individual device are altered by directing a beam of empty wave packets onto the device to augment existing wave packets of conduction electrons. The device is incorporated in a conventional aforementioned circuit and a steady-state signal is provided to the circuit input. The corresponding output is then quantitatively altered by the empty wave packets incident on the device and the encoded signal can be demodulated from the detector output.

Empty electron wave communication has advantages over conventional electromagnetic radiation communication similar to that provided by empty photon wave communication as disclosed in [ref-2] such as those with regard to stealth. However, the different physical characteristics of the two empty wave radiations provide distinctive advantages for each.

### Imaging Applications

The empty wave packets can be used for imaging applications. In this capacity, the modified FIG. 3A configuration represented in FIG. 12 as 8 includes detector 60 similar to that in the FIG. 11 configuration to detect the received empty waves and an analyzer 62 to quantify the detected empty waves. In this application the object 75 to be imaged is interposed between deflector means 19 and detector 60 on beam segments 36-38 where the object is transected by segment 37.

The empty waves quantified by analyzer 62 provide a single measure of the object's attenuation factor for empty waves along the transection path of beam segment 37. By methods well known in the art, multiple incremental relative parallel displacements of the object 75 and the corresponding multiple transection paths analogous to beam segment 37 provides for a projective 2-dimensional image of the multiple measured attenuation factors. If such measurements are combined with multiple incremental relative rotations of the object 75 and the transection paths of beam segments analogous to 37, tomographic 3-dimensional attenuation factor images of the object can be reconstructed by methods well known in the art.

Imaging with empty electron waves has several advantages over conventional methods. Notably, empty electron wave imaging deposits no substantial energy in the imaged object, an advantage shared with empty photon wave imaging as disclosed in [ref-2]. This absence of substantial deposited energy is an important advantage in biological imaging and other imaging applications where the object is adversely sensitive to energy deposition. Additionally, the attenuation of empty waves in different material compositions is distinct from that of other types of imaging radiation such as x-rays or ultrasound waves. Accordingly, images derived from empty electron waves can distinguish structural details of material compositions not seen with other imaging radiations including those of empty photon waves as in [ref-2]. Varying the de Broglie wavelength of those empty waves further improves their capability to distinguish such structural details.

The aforementioned imaging methods associated with FIG. 12 relate to transmission attenuation measurements of a beam interposed object. A person having ordinary skill in the art will recognize that the FIG. 12 detector 60 can be displaced from its depicted position of intercepting transmitted empty waves to a point where it can intercept empty waves reflected off of an object. If the output empty wave beam is temporally pulsed and spatially swept across an arc, the detected reflected empty waves can be utilized to characterize the object, its location, and its movement by methods well known in the art for radar and lidar. The stealth advantages of such empty electron wave imaging applications are similar to those of empty photon waves disclosed in [ref-2]. However, because of the different interactions of those respective empty wave radiations with matter, differing characteristics of the object are revealed with each.

### Applications of Empty Wave Beam Momentum

A person having ordinary skill in the art will recognize that, that the beam of empty waves emitted by the FIG. 3A configuration provides a momentum increment p≈m_{w}v for every electron emitted by source 10 where v is the electron velocity and the number N of magnets is sufficient to extract most of the wave probability of the electrons onto empty wave thereby maximizing the m_{w} extracted from a P=1 electron wave packet. Accordingly, the total force produced by those momentum increments is proportional to the source 10 beam current. The resultant reaction force of the FIG. 3A configuration is not strictly classifiable as a propellant-less inertial drive because the existence of that force relies on expelling empty particle wave packets that have a non-zero mass. When the expelled empty wave packets are derived from very high energy electrons the resultant specific impulse of the reaction is very high. In that process, the energy expended in accelerating those electrons can be efficiently recovered from the deflected occupied wave packets.

### Fusion Induced by Empty Electron Wave Packets

When a beam of empty photon waves intersects a beam of ordinary photon waves, the energy quanta on those ordinary waves equilibrate onto the formerly empty wave beam, see [ref-2]. A similar process occurs for particle waves. For example, a directed empty electron wave beam can readily penetrate deeply into a conductive metal atomic lattice since the beam is uncharged and is not subject to attenuation by classical electromagnetic ionization interactions. However, as that directed empty electron wave beam progresses through the metal atomic lattice, free conduction electrons can progressively equilibrate onto the formerly empty wave beam. In this process the velocity (or equivalently the de Broglie wavelength) of the source electrons and therefore also of the empty wave packets can be selected to match that of particular free electrons in the metal's Boltzmann distribution which might range from ˜10⁵-10⁶ m/s. Directed electrons are then delivered to points deep within the lattice in a manner not achievable with the disruption of a conventional high energy electron beam similarly directed at the surface of the lattice.

This process of delivering electrons deeply into an atomic metal lattice has application to inducing fusion of light nuclei densely loaded into the interstitial spaces of that lattice. Notably, that dense loading is facilitated by the atomic structure of particular metals such as palladium and titanium. The principal impediment to the fusion rate for those densely loaded nuclei is the Coulomb barrier. See [ref-6] and [ref-7].

The beam of empty electron wave packets incident on the lattice locally delivers electrons to the neighborhood of densely loaded nuclei and provides for charge screening that substantially reduces the Coulomb barrier. This process occurs without externally incident high energy radiation disruptive of the atomic lattice structure that critically facilitates the dense loading.

This method of inducing fusion in lattice loaded nuclei using beamed empty electron waves derived from low energy electrons has analogies to low energy muon beam induced fusion [ref-8] in the regard that both rely on inducing fusion by locally increasing the density of screening charges whereupon tunneling completes the fusion process. The methods disclosed here provide transient increased densities of empty electron waves proximal to a neighborhood of fusible nuclei that enhance charge screening by equilibrated conduction electrons thereby increasing the cross section for fusion.

The FIG. 3A output beam of empty wave packets directed at a metal lattice loaded with fusible nuclei constitutes a unilateral beam embodiment of the method for enhancing fusion. That unilateral beam embodiment is represented in FIG. 13 where only a single FIG. 3A configuration represented by 8A directs an output beam of empty wave packets on a metal lattice target 90 loaded with fusible nuclei.

The unilateral beam embodiment is further improved with a bilateral beam embodiment in which two opposing FIG. 3A configurations, such as 8A and 8B, direct their respective empty wave beams along opposing trajectories to an interposed metal lattice target 90. In that bilateral beam embodiment the sources of the two opposing 8A and 8B configurations are temporally synchronized and coherently emit electrons in a pulsatile mode. In that manner, the opposed waves meeting deep within the matrix advantageously produce transient standing waves of electrons equilibrated by the conduction electrons.

The entire multiplicity of FIG. 3A configurations depicted in FIG. 13 represents a still further improvement. The resultant multilateral beams are focally directed at a centrally located metal lattice target 90. That multiplicity of FIG. 3A configurations shown in FIG. 13 may represent a 2-dimensional version of a multilateral beam embodiment. Alternatively, in a 3-dimensional version, the depicted multiplicity of FIG. 3A configurations represent only a single, typical planar subset of FIG. 3A configurations that are uniformly, spherically distributed over 4π relative to target 90. In a preferred embodiment, the multiplicity of empty wave beams all have their respective sources temporally synchronized and emit electrons coherently in a pulsatile mode. Thereby approximately circular or spherical empty waves, respectively for the 2-dimensional and the 3-dimensional versions, are repeatedly delivered to a focal location of the lattice target 90.

Similarly, in a preferred variant of the unilateral beam using only a single FIG. 3A configuration such as 8A, a multiplicity of nearly unilateral focally convergent beams such as those of configurations 8A, 8C, and 8D collectively provide a 2-dimensionally increased intensity at lattice 90. In a 3-dimensional variant, configurations 8A, 8C, and 8D represent a typical planar subset of a multiplicity of FIG. 3A configurations that are uniformly distributed in a solid conical geometry. For either of these 2-dimensional or the 3-dimensional variants, the multiplicity of FIG. 3A configurations all have their respective sources temporally synchronized and emit electrons coherently in a pulsatile mode thereby collectively providing high intensity empty wave beams that are substantially unilateral upon incidence on lattice 90. The constructive mutual convergence of mutually coherent empty wave beams contributes to the equilibration of conduction electrons at the convergence focal region.

The utility of the foregoing configurations of empty electron wave beams resides in the ability of those beams to induce local charge screening deep within the lattice as free electrons equilibrate onto those waves. That process increases the fusion cross section of fusible nuclei within the lattice. A person having ordinary skill in the art will recognize that, that this method can be used together, in a complementary fashion, with methods that increase fusion cross sections by increasing the kinetic energy of the nuclei by utilizing conventional penetrating high energy electromagnetic radiation to selectively increase the kinetic energy of fusible nuclei densely loaded into metal atomic lattice [ref-8] and by magneto-constriction of the metal lattice.

In the interests of visual clarity, some ancillary aspects of the FIG. 13 assembly are not depicted. As noted in the foregoing, FIG. 3A configurations for generating a beams of empty wave packets are necessarily situated in a vacuum. The beam can be directed at a target by providing a sufficiently transmissive window in a vacuum containment vessel of such configurations. Those windows are optimally composed of non-conductive materials in which empty electron waves minimally equilibrate.

For fusion applications where one or more of those FIG. 3A configurations are utilized in generating empty wave beams, those beams are respectively directed through similar windows of a second containment vessel onto a metal lattice loaded with fusible nuclei that is located within that second vessel. The space surrounding that metal lattice within its containment vessel may have a high gas pressure of residual free molecules associated with the fusible nuclei not loaded into the lattice.

### Fusion Applications of Separated Wave Packets of Fusible Nuclei

The disclosure to this point has presented applications of duality modulation particle wave packet separation relating specifically to electrons. However, it is shown here that several important novel applications can be deduced from the duality modulation separation of other types of particles. Of particular interest are “particles” consisting of light, fusible nuclei.

The common atomic hydrogen ¹H nucleus, the proton, p, is by far the most prevalent fusible particle in nature. The proton is, like the electron, also an elementary spin ½ particle although the proton, unlike the electron, is known to have a micro-structure of quarks. Nevertheless, despite that micro-structure, the proton spin structure states have direct analogs with the electron spin structure states since both are elementary spin ½ particles. Accordingly, deductions regarding the manipulation of electron spin structure states can be directly extended to corresponding manipulations of proton spin structure states.

The proton is but one of a group of fusible nuclei or “fuel particles” that are widely considered to be significant candidates for generating controlled fusion. Unlike the proton, the other members of this group are nuclei consisting of two or more coupled “nucleons” (protons and neutrons). Three of these members are examined here specifically in the interests of determining their suitability in the present invention. Two are the nuclei of the atomic hydrogen isotopes ²H, deuterium, and ³H, tritium, where these two nuclei are respectively identified as the deuteron, d, and the triton, t. The third is the nucleus of the helium isotope ³He.

Because of its closer relevance to the silver Ag atom in the SGE, the triton, t, is considered first. The triton nucleons consist of a proton and a pair of neutrons. When t enters a magnetic gradient region such as that of a curved apex ridge magnet, the pair of neutrons effectively represents an uncharged, zero magnetic moment, massive appendage to the proton in analogy to the Ag atom relative to its unpaired electron in the SGE. For example, if θₚ<90° for the proton, the gradient field projectively condenses the p spin structures, retaining the particle-like t on a +z oriented δ-form spinor derived from the p spin structure.

Concurrently, the neutron pair subsystem effectively functions as a “closed-shell” in which the respective coupled spin structures of the two neutrons substantially have opposed orientations. There is no consequential effect on the particle-like n pair bound to the particle-like proton as a result of transit through the gradient magnet.

Accordingly, the passage of the spin ½ t through the gradient magnet is very similar to that of the spin ½ bare proton, p, aside from the dynamics of the deflection because of the increased effective mass in the former case. Dynamically, the effect of the mass of the appended n pair is analogous to the effect of the mass of the Ag atom in the SGE. With respect to the invention, the spin ½ t is fully applicable. A corollary to this substantial equivalence between t and p is that the wave packet probability splitting onto the occupied output channel of the magnet and the dark channel of the magnet are substantially identical processes for t and p.

The deuteron, d, is another important fusible particle and differs from p and tin that the coupling of the d's single p and n is manifested as a spin 1. As a result the d particle is treated as a composite two spin structure system in which the single n is not an inert mass-bearing appendage in the gradient separation process.

In d the p and n are observed to be in a triplet state where the orientation θ,φ of their respective spin structures are substantially the same. Consider for example, θₚ<90°. Then in a gradient field the particle-like p is trapped on a +z δ-form spinor and the particle-like n is similarly trapped on a +z δ-form spinor. The observed quadrupole moment of d indicates that these δ-form spinors are collinear which causes the magnetic moments of the proton and neutron to be additive in substantial agreement with observation. Moreover, the p and the n wave packet probability split onto the gradient magnet's occupied output channel and dark output channel are proportionately the same for both of those nucleon members of d. Consequently, with respect to the invention the functionality of d can be treated as substantially equivalent to that of p and of t.

The ³He nucleus constitutes an inversion of p and n relative to the triton, t, with regard to the invention. In that inversion the p pair of the ³He nucleus functions as a massive inert appendage of the n and the probability projections onto the occupied output channel and the dark channel of the gradient magnet are those of the n in the case of the ³He nucleus. Dynamically, the only substantial change is due to the double charge of the ³He nucleus relative to that of t.

The above analyses show that the ³He nucleus and the other considered nuclei p, t, and d are all substantially functional with respect to the invention even if they have a spin>½ and are comprised of more than a single nucleon. A similar analysis shows that this functionality extends broadly to other important fusible nuclei.

Accordingly, the response of wave packets of the above nuclei to magnet configurations such as that in FIG. 3A is fundamentally the same as it is for electron wave packets. Directions of magnetic moments may be reversed relative to spin direction, e.g. for p vs e, causing an inconsequential reversal of the order of the separated empty and occupied wave packets. For a given magnetic gradient, the magnitude of the separation of the empty wave packets and occupied wave packets is significantly less for wave packets of nuclei than it is for wave packets of electrons because of the relative masses and magnetic moments. However, for the purposes of the present invention, in contrast to demonstrations of DQ, that separation need only be microscopic, sufficient to retard the two from resolving back to a single wave packet after the sudden onset of the magnetic field.

Suitable parameters of particle velocities and magnetic gradients for non-adiabatic duality modulation separation of the wave packets can be systematically determined by polarimetry methods as disclosed above.

With regard to duality modulation separation of nuclei wave packets it is notable that there have been successful DQ experiments performed with neutrons using magnetic gradients comparable to those specified in the present disclosure. [ref-9] Since neutrons have a mass and a magnetic moment comparable to those of the light fusible nuclei, the successful results of those performed SGE neutron experiments imply that the LR separation of wave packets would also occur for those nuclei using the magnetic gradients specified herein for electrons. Several novel fusion applications of those separated occupied and empty wave packets of nuclei are disclosed here.

With regard to the use of nuclei instead of electrons, FIG. 13 alternately represents the various arrangements of FIG. 3A configurations for directing beams of empty nuclei wave packets at a metal lattice loaded with fusible nuclei. The sources of the FIG. 3A configurations then provide beams of those nuclei instead of electrons. Empty waves derived from low energy fusible nuclei are directed at a metal lattice densely loaded with fusible nuclei. Velocities of those empty nuclei waves should very approximately match the peak Boltzmann distribution velocities of loaded fusible nuclei.

Directed nuclei empty waves provide the means for increasing mutual tunneling of neighboring fusible nuclei deep within the lattice by transiently increasing the already present wave intensity between the nuclei. In analogy with the use of empty electron waves relative to FIG. 13, a single FIG. 3A configuration or multiple FIG. 3A configurations may be similarly deployed to directionally achieve that increased wave intensity of the nuclei loaded in the metal lattice.

Optimally, the empty waves provided by the one or more FIG. 3A configurations should be derived from the same type of nuclei as those loaded in the metal lattice. These might optimally be deuterons.

This method can be used in combination with a method such as charge screening by focally directed empty electron waves as disclosed herein for FIG. 13, or in combination with other methods to selectively kinetically enhance the loaded nuclei such as synchronized magneto-constriction of the lattice or by high energy photon irradiation to energize the lattice loaded nuclei [ref-7].

In the foregoing fusion application, the empty separated wave packets of nuclei are utilized. In the following, several additional fusion applications are disclosed that instead utilize the occupied separated wave packets of nuclei. In these applications a beam of occupied empty wave packets that excludes the empty wave packets can be provided by utilizing occupied wave packets derived from a deflection means such as depicted in FIG. 3A. However, in the following applications of occupied wave packets, the accompaniment of the longitudinally separated empty wave packets does not affect the functionality of the applications and such deflection means are not utilized.

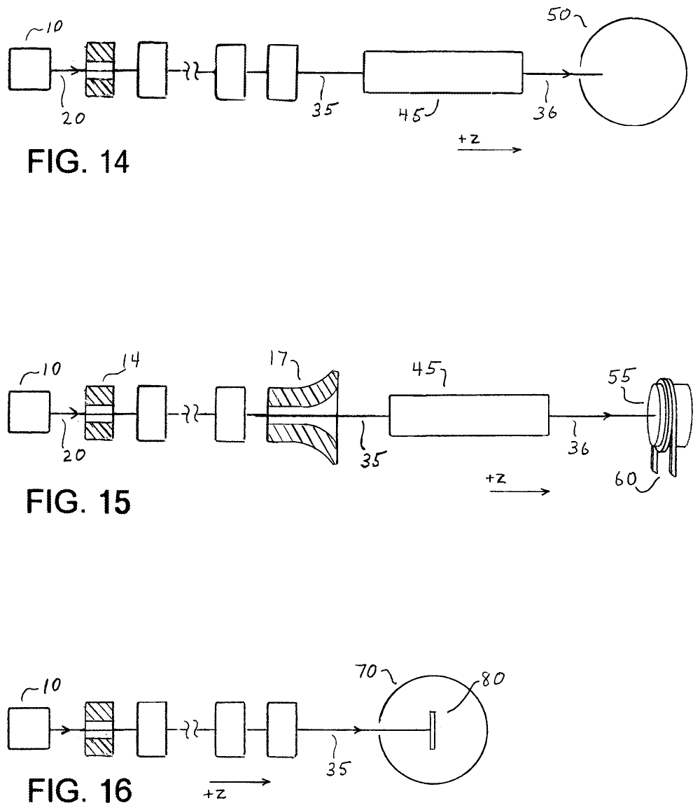

FIG. 14 depicts a method with analogies to muon-induced fusion. [ref-8] A modified FIG. 3A configuration directs highly enriched particles such as tritons into an enclosure 50 filled with a gas such as deuterium. Source 10 provides a beam of tritons at a suitable velocity (2000 m/s) to induce wave packet separation upon passage through a multiplicity of magnets to highly enrich the occupied triton wave packets on output beam segment 35.

The occupied wave packets that emerge from source 10 onto trajectory 20 are “ordinary” with respect to duality modulation and have a normalized probability P=1. After an incident P=1 wave packet with a polar orientation θₚ transits the first half of the first magnet, it has a reduced probability of P=cos²(θₚ/2) because of the extracted empty wave packet. On average, this process reduces probability to P=0.89. With each half-magnet transit the occupied wave packet loses 11% of its remaining probability. Then if the multiplicity of magnets consists of 10 magnets, the average probability of an occupied wave packet on trajectory 35 is P=0.89²⁰=0.1. (In the presently described embodiment of FIG. 14, component 45 is omitted and beam segment 35 transitions to beam segment 36.)

By natural exchange processes, the tritons on segment 36 entering enclosure 50 rapidly replace one of the deuterons in deuterium molecules, creating t-d molecules. The extremely large asymmetry in the respective wave packet probabilities of the highly enriched triton and the ordinary deuteron in the t-d molecules results in enhanced tunneling of the triton onto the deuteron wave packet. (For a given particle-like entity, enrichment is inversely proportional to the wave probability of the wave packet on which it resides. A high enrichment implies a probability-poor wave state.)

This tunneling process occurs because quantum forces calculable from the Schrodinger equation strongly accelerate the beamed highly enriched (P˜0.1) triton wave packets onto the ordinary (P=1) deuteron wave packets of the ordinary non-enriched occupied wave packets in the target thereby significantly increasing the fusion cross section between the beamed and target nuclei. This differential in the probability densities of the respective enriched and ordinary non-enriched wave packets is identified as “enrichment asymmetry” and is associated with their enhanced mutual tunneling.

Notably, compared to muon induced fusion, even a relatively small increased fusion cross for the t-d molecules as a result of the triton wave packet being highly enriched is very consequential because the triton is effectively a stable particle relative to the muon.

In muon induced fusion, after a t-d molecule is formed with a muon, fusion is rapidly catalyzed by tunneling in about 0.5×10⁻¹² s. (The rapidity of this process is fortuitous since the mean life of the muon is only 2.2×10⁻⁶ s. Following fusion in a given molecule the muon is released and can similarly catalyze multiple t-d molecules before it decays, but for a variety of reasons the net energy produced is negative.)

In contrast, an enriched wave packet of a triton nucleus in a t-d molecule may induce fusion much more slowly than the 0.5×10⁻¹² s of a muon t-d molecule. However, since the triton nucleus itself is comparatively radioactively stable, even a macroscopic mean fusion tunneling time greatly exceeding that of the muon would still be advantageous to the utility of using enriched triton wave packets to enhance fusion in t-d molecules.

In an alternative embodiment of the FIG. 14 configuration, highly enriched wave packets of nuclei such as tritons on beam segment 35 enter linear accelerator means 45 well known in the art [ref-10] which increases the kinetic energy of the occupied wave packets non-magnetically to a level suitable for inducing fusion, e.g. ˜70 keV in t→d reactions, with target nuclei such as deuterons while leaving the magnetic moment alignment and enrichment properties of the “projectile” wave packets unaltered. The energized, highly enriched wave packets emerge from linear accelerator means 45 onto beam segment 36 and enter a containment vessel 50 in which of a hot plasma is maintained. The plasma might typically be deuterons and electrons.

In conventional methods for achieving fusion known in the art, a high temperature plasma that includes fusible nuclei is augmented by the kinetic energy of fusible nuclei beamed into that plasma. Relative to such methods, the present embodiment of the FIG. 14 configuration further enhances fusion by the novel use of highly enriched beamed projectile wave packets that increase tunneling with the plasma target wave packets by their respective wave packet probability asymmetry.

FIG. 15 depicts a beam to target method well known in the art of controlled fusion but augmented in the present disclosure by enrichment and alignment methods disclosed here to increase fusion cross sections. Highly enriched and aligned nuclei are beamed by a configuration that includes a divergent bore magnet 17 as the final magnet. A pulsed electromagnet 60 such as depicted in FIG. 3c temporally imparts a high gradient magnetic field to stationary fusible target nuclei 55 encircled by electromagnet 60. Magnets 17 and 60 facilitate axial alignment of mutual magnetic moment alignment of beam and target particles. Solid targets such as ¹¹B and ⁷Li with beamed protons would advantageously provide p→¹¹B and p→⁷Li aneutronic reactions.

The source 10 provides a beam of “projectile” nuclei, e.g. protons, onto beam segment 20 at a suitable velocity such as ˜2000 m/s to induce wave packet separation upon passage through a multiplicity of magnets, beginning with magnet 14 depicted in cross section, to highly enrich the occupied wave packets on output beam segment 35.

The divergent geometry of magnet 17 provides a substantially reduced output gradient. As a result, the transition from a substantial magnetic field to a negligible magnetic field is rendered insufficiently sudden to induce a condensation of an exiting occupied wave packet. In the absence of that condensation, the occupied wave packet's axially aligned magnetic moment while within the bore of magnet 17 is unperturbed as it exits the magnet and continues, still axially aligned, onto beam segment 35.

The occupied wave packet enters linear accelerator means 45 well known in the art [ref-10] which increases the kinetic energy of the projectile nuclei non-magnetically to a level suitable for inducing fusion with target nuclei while leaving the magnetic moment alignment and enrichment properties of the projectile wave packet unaltered.

The occupied wave packet, exiting accelerator means 45 onto beam segment 36, is incident on solid target 55 which may be composed of ¹¹B or ⁷Li. Solid target 55 is located within a high-field impulse electromagnet loop 60. An abrupt current impulse imparted to electromagnet loop 60 generates a transient temporal longitudinal magnetic field and gradient relative to the wave packets of the target nuclei. That transient field induces wave packet condensation and (longitudinal) axial alignment of their magnetic moments. In the reference frame of stationary target nuclei wave packets, a transient temporal magnetic field can provide equivalency to the magnetic field experienced by moving nuclei wave packets transiting a magnet such as 14 specifically with respect to axial alignment of magnetic moments.

Beam source 10, longitudinal accelerator 45 and electromagnetic loop 60 are synchronized such that pulses of highly enriched occupied projectile nuclei wave packets with axially aligned magnetic moments are incident on target nuclei wave packets with axially aligned magnetic moments. In that process the fusion cross section is enhanced by two distinct novel methods deduced from LR, (1) providing mutual magnetic moment axial alignment and (2) providing asymmetric wave packet probabilities.

With regard to (1), statistically, for each encounter of a projectile and target nucleus in the FIG. 15 configuration, there is a 50% probability that their respective magnetic moments are in identical axial alignment where both are either aligned along +z or along −z. Colliding nuclei are well known to have a substantially enhanced their fusion cross sections when they are mutually polarized along a common axis. [ref-11] Polarization along a particular axis implies that the objectively real magnetic moment has a probability distribution cos²(θ/2) of being aligned at a polar angle θ with respect to that axis. Consequently, compared to unpolarized nuclei, a pair of nuclei mutually polarized along a common axis have a significantly increased relative alignment of their respective magnetic moments which, as noted, is well known to be accompanied by a substantially enhanced fusion cross section. It may readily be appreciated that the identical mutual alignment of magnetic moments provided by the FIG. 15 configuration is a substantial further improvement over the relative alignment associated with polarization along a common axis. That substantial further improvement is accompanied with a substantial further improvement in fusion cross section relative to mutual polarization.

With regard to (2), the FIG. 15 configuration probability asymmetry between the projectile nuclei and the target 55 nuclei provides for an enhanced fusion cross section in a process directly analogous to that for the FIG. 14 configuration. The probability asymmetry is most readily achieved by “enrichment asymmetry” in which the beamed projectile beam nuclei are highly enriched, i.e. with a small wave probability, and the stationary target nuclei are ordinary, i.e. with an unmodified wave probability.

FIG. 16 depicts a variant of the FIG. 14 method. (In the FIG. 14 method enriched particle wave packets such as for tritons are used to enhance fusion in molecules such as t-d.) In FIG. 16 the particle beam source 10 and the cascade magnet configuration similarly provides a beam of enriched particle wave packets, such as for tritons, onto beam segment 35. In FIG. 16 the enriched triton wave packets enter gas containment vessel 70 and are incident on a metal lattice 80. The metal lattice 80 may be held at a small negative potential to facilitate the adsorption of the triton wave packets.

The lattice 80 can be fractionally loaded with enriched triton wave packets in this process and subsequently loaded with fusible particles such as deuterons by pressurizing vessel 70 with gaseous molecular deuterium. Alternatively, the lattice 80 can be substantially preloaded with deuterons before enriched tritons are directed into vessel 70.

In either case, within the lattice the preponderance of loaded deuterons ensures that nearest neighbor nuclei of loaded enriched tritons are predominately deuterons. The well-known characteristic packing proximity and charge screening advantages associated with the lattice [ref-6] contributes to mutual tunneling fusion of tritons and deuterons that is further enhanced by the enrichment of the triton wave packets. That tunneling can be still further enhanced by complementary methods such as magneto-constriction of the lattice and irradiation by energetic photons. See [ref-7].

What is claimed is:

1. A system for duality modulation separation of charged particle wave packets comprising:
a magnet cascade including a plurality of magnets arranged coaxially along a length of a beam path, wherein the each of the plurality of magnets comprises a magnetic field axially symmetric relative to the beam path, the plurality of magnets creating magnetic gradient regions proximate to an initial end and a terminal end of each of the plurality of magnets along the beam path;
a beam source coaxially aligned with the magnet cascade at an initial end of the beam path, the beam source providing a selected particle beam projected along the beam path;
a particle deflection means located at a point along the beam path beyond the terminal end of a final magnet of the magnet cascade;
wherein a selected particle emitted from the beam source travels along the beam path and encounters a first initial magnetic gradient region as it approaches the initial end of a first magnet, encounters a first terminal magnetic gradient region as it passes the terminal end of the first magnet, encounters a final initial magnetic gradient region as it approaches the initial end of a last magnet, and encounters a final terminal magnetic gradient region as it passes the terminal end of the last magnet;
wherein a significant characteristic fraction of a particle wave packet of the selected particle is an empty wave packet longitudinally separated from a particle-occupied wave packet along the beam path when the system is tuned with characteristic magnetic gradients and a characteristic particle beam velocity for the selected particle type;
wherein the selected particle emerging from the terminal end of the last magnet comprises a highly enriched occupied wave packet and a plurality of empty wave packets, wherein a number of the plurality of empty wave packets is twice the number of magnets in the magnet cascade, and wherein the highly enriched occupied wave packet is enriched by the separation of the plurality of empty wave packets as the selected particle traverses the magnetic gradient regions along the beam path; and
wherein the highly enriched wave packet is deflected by the particle deflection means along a deflected beam path and wherein the plurality of empty wave packets continue on the beam path forming an empty wave packet beam.

2. The system of claim 1, wherein the last magnet of the magnet cascade comprises a terminal magnetic gradient that is below a threshold for inducing duality modulation of the charged particle wave packets, and wherein a magnetic moment of the highly enriched occupied wave packet remains axially aligned.

3. The system of claim 1, further comprising:
a secondary deflection means for deflecting the highly enriched occupied wave packets deflected from the selected particle beam creating a secondary beam consisting of highly enriched occupied wave packets, and wherein only empty wave packets continue along the beam path.

4. The system of claim 1, wherein the plurality of magnets of the magnet cascade are each hollow cylindrical magnets having an outer radius and comprising a central a bore having an inner radius, wherein the particle beam is substantially centered through the coaxially aligned bores of the plurality of magnets.

5. A system for producing transient alignment of magnetic moments of stationary target nuclei wave packets comprising:
a solenoidal coil magnet encircling the stationary atoms of nuclei; and
a pulsed electrical power supplied to the coil that generates a concurrent transient temporal axial magnetic gradient, wherein the magnitude of the transient temporal axial magnetic gradient is sufficient to induce a concurrent transient duality modulation alignment of nuclear magnetic moments, and wherein the magnetic moments of the stationary target nuclei are transiently axially aligned relative to the transient axial gradient of the magnet.

6. The system of claim 1, wherein the beam source is an electron beam source, wherein the selected particle is an electron, the system further comprising:
an energy recovery device, and wherein a beam of enriched electron wave packets travelling along the beam path is directed to the energy recovery device, and wherein a projection of a beam of empty electron wave packets along the beam path, results in a net reaction force in a direction opposite to a direction of travel of the electron.

7. The system of claim 1, wherein the beam source is an electron beam source, wherein the selected particle beam is an electron beam, wherein the system is used for communications, the system further comprising:
a modulation means for encoding a signal into electron wave packets of the electron beam, wherein the transmitted beam of empty wave packets includes the modulated signal; and
a receiver including detector means sensitive to incident empty electron wave packets, wherein the receiver includes a demodulator to decode the signal encoded in the empty electron wave packet, and wherein an encoded signal is transmitted to the receiver on an empty electron wave packet beam that is not detectable by conventional means.

8. The system of claim 1, wherein the beam source is an electron beam source, wherein the selected particle beam is an electron beam, wherein the system is configured for imaging objects with a beam of empty electron wave packets, the system further comprising:
a receiver including a detector means sensitive to incident empty electron wave packets, the receiver configured to conventionally compile and process detector output signals, wherein an object interposed between the beam source and the receiver is intersected by the electron beam, and wherein a relative object attenuation of the electron beam in the object for that particular linear path measured by the detector, and wherein, based on a plurality of attenuation measurements are taken for a plurality of sampling paths through the object at a corresponding plurality of orientations, the system generates a tomographic image of the object without consequential energy deposition in the object from the beam of empty electron wave packets.

9. The system of claim 1, wherein the beam source is an electron beam source, wherein the selected particle beam is an electron beam comprising an empty wave packet beam including empty electron wave packets, wherein the system is configured to induce fusion by charge screening, the system comprising:
a metal lattice loaded with fusible nuclei, wherein the empty wave packet beam is directed at the lattice and wherein metal lattice conduction electrons proximate to the empty wave packet beam equilibrate onto empty electron wave packets of the empty wave packet beam increasing a charge screening of fusible nuclei proximate to the empty wave packet beam path.

10. The system of claim 9, further comprising a plurality of electron beam sources and a corresponding plurality of magnet cascades generating a plurality of empty wave packet beams, wherein the plurality of empty wave packet beams are focused at a metal lattice loaded with fusible nuclei, and wherein equilibrated metal lattice conduction electrons on the plurality of empty wave packet beams enhance a charge screening at the focal region of the empty wave packet beams within the lattice.

11. The system of claim 1, wherein the beam source is a fusible particle beam source, wherein the selected particle beam is a fusible particle beam, wherein the system is configured for inducing fusion by enhanced tunneling of fusible particles utilizing fusible-particle empty wave packets comprising:
a metal lattice loaded with fusible particles, wherein the fusible-particle empty wave packet beam is directed at the metal lattice, and wherein the empty wave packets of the fusible-particle empty wave packet beam increase the wave intensity between neighboring wave packets of fusible particles within the lattice encouraging fusion of neighboring fusible particles based on a mutual tunneling to fusion of those neighboring fusible particles.

12. The system of claim 11, further comprising a plurality of fusible particle beam sources and a corresponding plurality of magnet cascades generating a plurality of empty fusible particle wave packet beams, wherein the plurality of empty fusible particle wave packet beams are focally directed at a metal lattice loaded with fusible particles, wherein the empty fusible particle wave packets on the focally directed fusible particle beams further increase a wave intensity between neighboring wave packets of fusible nuclei within the lattice enhancing a mutual tunneling to fusion of neighboring fusible particles.

13. The system of claim 1, wherein the beam source is a fusible particle beam source, wherein the selected particle beam comprises a highly enriched fusible particle beam, wherein the system is configured for inducing fusion by enhanced tunneling of fusible particles utilizing fusible-particle empty wave packets comprising:
a target of gaseous molecules with atomic nuclei consisting of ordinary wave packets of fusible particles, wherein the fusible particle beam is directed into the target of gaseous molecules, wherein the highly enriched wave packets of fusible particles displace ordinary wave packets of fusible particles in the gaseous molecules; and wherein the highly enriched wave packets of fusible particles exhibit enhanced fusion by tunneling onto ordinary wave packets of fusible particles that remain in target molecules.

14. The system of claim 1, for inducing fusion by enhanced tunneling of enriched wave packets of fusible particles onto ordinary wave packets of fusible particles in a plasma state further comprising:
a source beam of fusible particles for the generator; and
a linear accelerator for substantially increasing the kinetic energy of charged particle wave packets; and
a plasma target of ordinary wave packets of fusible particles and electrons in ionic form; and
wherein, the generator output beam of enriched particle wave packets is directed at a linear accelerator for substantially increasing the kinetic energy of the enriched fusible particles; and
wherein the resultant beam of high energy, enriched fusible particles is directed into the plasma target; and
whereby the high energy, highly enriched wave packets of fusible particles exhibit enhanced fusion by tunneling onto the ordinary wave packets of fusible particles.

15. The system of claim 1, wherein the beam source produces a pulsed beam of fusible particles for inducing fusion by enhanced tunneling of enriched fusible aligned wave packets onto ordinary wave packets of fusible aligned particles, the system further comprising:
a divergent geometry of a terminal output bore of the last magnet resulting in a substantially reduced terminal magnetic gradient, wherein the fusible particles of the enriched particle wave packets are axially aligned;
a linear accelerator into which the pulsed beam of fusible particles is directed, substantially increasing the kinetic energy of the fusible particles;
a solenoidal coil magnet with a pulsed electrical power supplied to the coil that generates a concurrent transient temporal axial magnetic gradient;
stationary target atoms with fusible-particle nuclei encircled by the solenoidal coil magnet where those nuclei are transiently driven into axial alignment by the coil magnet gradient;
wherein the beam pulses are synchronously incident on the stationary target atoms during the pulsed imposition of transient temporal axial magnetic gradient; and
wherein mutual axial alignment, high collision energy, and enrichment asymmetry all concurrently contribute to inducing mutual fusion of the beam particles and the target particles.

16. The system of claim 1, configured to induce fusion of highly enriched fusible particles wave packets and matrix loaded ordinary fusible particles wave packets, wherein the beam source is a fusible particle beam source, and the system further comprises:
ordinary wave packets of fusible target particles densely loaded into a thin metal matrix;
a gas containment vessel in which the metal matrix is located, the gas containment vessel pressurized with molecules having the target particles as nuclei thereby maintaining the densely loaded condition of the matrix;
wherein the beam of highly enriched fusible particles is directed onto the densely loaded metal matrix; and the highly enriched wave packets of fusible particles enter the densely loaded metal matrix, and wherein the proximity of the highly enriched fusible particle wave packets to the wave packets of fusible target particles in the densely loaded metal matrix results in mutual fusion by enrichment asymmetry.
